(19) United States
(12) Patent Application Publication
(10) Pub. No.: US 2007/0169482 A1
(43) Pub. Date: Jul. 26, 2007

(54) Aspects derived from a discovery of the inherent properties and traits of planar curves herein classified as Limaconic Motation technology

(76) Inventor: Gerald N. Weightman, Rockford, IL (US)

Correspondence Address: Gerald N. Weightman, 716 HOBAN AVE, ROCKFORD, IL, 61101, US

(21) Appl. No.: 11/338,536

(22) Filed: Jan. 24, 2006

(51) Int. Cl. F03G 7/00

(52) U.S. Cl. 60/721

(57) ABSTRACT

A personal discovery of the numerous performance advantages that will result from the integration of entitled “Limacon of Pascal” planar curve properties inspired the present inventor to begin materializing an extremely efficient means of capturing and processing fluid stream energy. As the development of a new technology progressed the unique traits and properties of additional planar curves, both named and untitled, became evident and viable.

### BACKGROUND—DEFINITION OF TERMS USED IN TEXT

The following definitions of coined or unorthodox terms will apply to one or more of the aspect applications to Limaconic Motation Technology.

The terms “limacon” and “limaconic” are derived from the physical shape of an edible bean, a snail, or the human heart which appeared to be similar to the contour of a particular planar curve originally published by Etienne and Blase Pascal in the early 17^{th} century.

The term “motation” is coined from a combination of the words “motion” and “rotation” to more accurately describe the unique movements portrayed by the Limacon and several other planar curves including Lemniscate of Bernoulli; Rose of Grandi and Folium of Descartes.

The term “panemone” is a rarely used ancient word which describes the shape of a panel, plate, paddle or plank cut from the longitudinal axis of a solid log.

The term “drag” is used in the present text in the sense of matter being pulled along by the forces of a fluid stream rather than the aeronautical sense of being a resistance force.

The term THEMP is an acronym coined from the words Thermal; Hydraulic; Electrical; Mechanical and Pneumatic; used to identify the forms of power which may be generated from “Fluid Streem Innergee Absorption Spheres” which utilize said Limaconic Motation technology.

The abbreviation FSIAS is used to quickly identify a cradled assembly entitled “Fluid Streem Innergee Absorption Sphere.”

The abbreviation EHGCS is used to quickly identify Limaconic aspects in the application of “Epicyclical Hybrid Gearing Control System,”

The term ALRID RecipVATAS is an acronym developed to identify a mechanical Asynchronous Linear Reciprocating Inching Device that supports a Reciprocal Velocity Acceleration and Torque Accumulation System which then feeds rotational power to any of the various THEMP generators or to caldarium storage facilities.

The term Armsand Legs HuManual Engine is an acronym developed to identify the modification of the said ALRID RecipVATAS mechanism whereby multiple human beings can compound physical energy to drive a rotary power shaft.

The specific acronym KatKanFLOW is derived from the Aspect of Focused Limaconic Orbiting Waves emitted from the Nautical Propulsion Instrument as well as the Katamaran Kanew which is the empirical means being utilized to judge the effectiveness of various aspects of Limacon and Lemniscate planar curves.

“Reverse Paracellis” is a comic industrial engineering phrase which uses the misspelled name of a 16^{th} century Swiss alchemist to identify the unusual properties in mechanical devices having gear trains where pitch diameter ratios can be reversed. It also is applied when a power input position can be reversed with the power output position as in the said RecipVATAS system and, more commonly, in the use of airfoil propeller blades as wind energy absorbers.

### BACKGROUND—FIELD OF DISCOVERY AND INVENTION

The embodiment of a said “Fluid Streem Innergee Absorption Sphere”, taught in the extant aspect application, is a necessary means of effectively demonstrating the inherent traits, or properties, of Pascal's Limacon; the Lemniscate of Bernnoulli; the Rose of Grandi and other yet unnamed planar curves. The extant embodiment requires several sub-assembly components that are aspects of the present patent application.

### BACKGROUND—CHRONOLOGY REGARDING ARCHIVAL RESEARCH AND REFERENCES TO PRIOR ART

An embargo in the early 1970's era by a cartel of petroleum rich nations shattered the complacency of many industrialized nations. The curre00000000000nt era's sharp increases in the cost of crude oil and natural gas supplies is again seriously endangering commerce and living costs. However, an enduring benefit of the serious economic threat three decades ago is the continuing endeavor to develop practical technologies and means of utilizing all naturally renewable sources of energy.

Capturing wind energy for conversion to useable power in the 1970 and 1980 period became one of the most publicized of renewable energy endeavors. A flurry of initiatives suddenly found support from industrial and government leaders of affected nations. Gusts of magazine essays and journals heralded the progress of innovative new ideas, re-inventions of old technologies and progress in utilizing hi-tech aircraft propeller designs for absorbing wind energy.

These essays, during the early and middle 1970's, sparked the interest of the present Aged Tinkerer. I involved myself in a personal hobby of researching the methods that ancient, medieval and modern cultures had devised to utilize wind or flowing water energy as an aid in their efforts to ease the burdens of manual labor.

### ARCHIVAL RESEARCH OF PRIOR ART

I knew that wind energy has been used for many centuries to give power to sailing ships. The simple punt sail of ancient Egyptian boats became intriguing to me. I found that by the seventh century AD, both Persian and Chinese cultures were using a vertical axis device having a number of fixed radially mounted sail cloths or paddles for pumping water or milling grain.

Since the ethnic cultures at that period apparently were without knowledge or skills regarding gears, in order to continually change the relative angle of the paddles in relation to the wind direction, they erected fences or stone shelters to blo000ck wind forces on the return side of progressive rotation.

I was also well aware that botanical phenomenon within nature's order can provide many clues regarding how we, as sapient creatures, may utilize the mechanics of nature. It is known that trees and shrubs, having been endowed with a multitude of botanical functions within the order, are among the most highly efficient absorbers of basic energy sources—especially wind streams.

Long periods were spent, during my initial searching period, in observing the natural mechanics taking place in groves of trees as wind energy is absorbed. The independent, yet inter-cooperative symbiotic action of cantilevered leaves, stems, and flexible limbs, which are firmly attached to a strong anchored trunk, provide quick reaction to micro-gusts that occur within energetic wind streams. Aspen and poplar trees make this phenomenon easier to observe.

Orbicular or arcuate leaves provide evidence of the importance of the Area Difference Principle: the ratio of face area to edge area of the leaves. In tree leaves this ratio can be very large—from about 16:1 to more than 80:1. People who are familiar with the physical principles regarding aircraft wings and propellers might refer to this measurement as the Airfoil Thickness Ratio. Frequently the A. T. R. of propellers and wings is within a critical range near 6:1.

Attention is called to the fact that tree leaves could easily be classified as said panemones but certainly not airfoils, as is the classic case of aircraft wings or propellers. The higher efficiency of trees and shrubs over airfoil propellers in regard to the absorption of wind energy does not mean that tree-like configurations could be an appropriate choice to emit power for flight. However the attribute of flexibility, the variety of possible shapes and the surface texture of said panemones is relevant.

My curious interest in punt sails, paddles and leaf forms brought to me an understanding that these simple panemonic shapes, which were found useful in ancient times, are not without intrinsic merit. However I was also warned, and somewhat confused, by the arguments that absorption of wind energy is seen as requiring an entirely different mechanical system than emitting power to fly through it.

I then proceeded to make a very precise layout drawing of the angular progress which a plurality of panels must follow in an orbital pathway about a central point in order to be efficient absorbers of fluid stream energy. The planar curve that was generated by our layout perfectly matched the long neglected Limacon planar curve that Etienne Pascal and his son, Blasé, developed during the early 17^{th} century. The Limaconic rosette is somewhat similar in shape and function to Bernoulli's Lemniscate, to a Curtate Cycloid and to the Three Leaf and Grandi Rose planar curves.

My recollection returned to a strange comment I had read in a 1963 edition of the Life Science Library publication entitled “Mathematics” (PP 84). The editor, David Bergamini, and the consultants: Rene Dubos, Henry Marganau and C. P. Snow, dismissed all the planar curves with the statement that said: “These fancy curves with fancy names are examples of showmanship” and “have little practical value.”

Suddenly this present Aged Tinkerer came to the realization that I had, by chance, discovered an equation, (r=b+a cos 0) that had been almost totally ignored for nearly four hundred years. It became apparent that the formulation could be extremely useful in the development of mechanisms to capture fluid stream energy.

Initial Prototype Models

This discovery by the said Aged Tinkerer that the inherent properties of the said Pascalian Limaconic planar curve could serve as the elementary foundation for obtaining higher efficiencies in the function of absorbing fluid stream energy, (sic. wind and flowing water) and in the emission of a focused stream of high velocity fluid power, invigorated the said Tinkerer to begin a lengthy multi-decade effort of developing combinations of essential components which would solve, or reduce, many of the known deficiencies and public objections to the ubiquitous use of airfoil lifting force propellers for this task.

So I then entered the model building stage of my new hobby. Utilizing a very simple plastic right angle drive, similar to those used on fertilizer spreaders, as a central component I rigidly attached 3 cogged pulleys of size 1 to each of the dual hubs of the output shaft housing. Several other components such as: a plurality of discs, axles, plates and size 2 pulleys were assembled into units that looked like Ferris wheels. The central axis of said Ferris wheels were rigidly attached to the output shafts of the right angle drive. Cogged belts were connected from said size 1 pulleys on the housing to the said size 2 pulleys which then caused the simulated Ferris wheels to rotate when the input shaft of the right angle drive was manually rotated.

The construction of this miniature display, which had an orbital diameter of 4.5 inches, became one of the critically important steps in our learning and discerning process. This elementary model served to reveal many of the inherent characteristics that said “Limaconic Motation” would display.

I began searching patent archives and commercial product booklets for a mechanism or device to control the relative angularity of rotating panels in a Limaconic motion mode. When I found nothing of merit I began arranging a plurality of cams, rods, levers, gear and racks plus one-way roller clutch bearings in an arrangement that resulted in an Asynchronous Linear Reciprocating Inching Device.

My hope at that period was that this unique device might accomplish the need to physically connect the central axis of a revolving wheel with the remote axis of a plurality of panemones positioned along extended radial support arms. A prototype of said Inching Device verified that it could be a means of connecting the proximate and distal positions. But backlash in the cams, in gearing and the connecting joints of the prototype version generated lost motion. From physical testing we became aware that a precise angular relationship of the panemones must be always be maintained for continuing efficiency.

However, the unique prototype design of the said Inching Device demonstrated some important properties that could be further developed for use in tasks of velocity acceleration and torque accumulation as well as other devices for human exercising and locomotion.

Publicized Industrial Progress in the Advancing Art of Windmills

At that point in time, approximately six years after the said oil embargo began, an awakened scientific and engineering body had produced several new concepts as well as revival of mechanisms that were introduced in past decades. One of the broadest synoptic reviews of the renewed endeavor was written by Victor Chase. His review appeared in the November 1978 issue of Popular Science magazine entitled: “13 Wind Machines”.

A reality, which was fully conceded in the opening paragraphs of the Popular Science essay, was the fact that the overwhelming share of U.S. Department of Energy development funds had been awarded to giant corporations promoting the use of aircraft propulsion technology. A suddenly reviving windmill industry, that had grown up in the United States by utilizing hands-on innovation in the earlier decades of the century, had been executed by the Rural Electrification Act in the 1930's era. Except for a few showcase grants of development funds to cover DOE's speculations, the unbalanced approach used to expand and advance technology, appeared to make the odds slim for a resurrection in the United States of a path formerly used; but that several other nations continue to find successful. That formerly used pathway was serious consideration of ideas, notions and prototype devices that small business people might put forth. Unfortunately it was not found appropriate by industrialists or investors in the United States. The ubiquitous airfoil propeller became king of the mountain and the inherent problems that “daisy wheels” bring to the technology were to be overlooked.

However, lineage in the Popular Science essay was given to several vertical axis means for capturing the winds because this orientation usually placed the output rotation near ground level, which is a great advantage in installing power translation equipment. Most of the other innovative or odd approaches were reported as being seen to be impractical and given little chance for success.

A reinvention of the Darrius troposkein rotor, which was originally patented in 1931, was highly touted for its potential of overcoming many of the operational problems derived from the use of airfoil propellers. Sandia Laboratories in Los Alamos, N.M., the Department of Agriculture site in Bushland, Tex., Alcoa Aluminum Co, center in Pennsylvania, the National Research Council in Ottawa, Canada and the Elektro G.m.b.h. of Winterthur, Switzerland had devoted costly effort to the revival of this promising method.

Although a series of frustrating accidents delayed the deployment of production units, by the late years of the 1980 decade and early 1990, over 500 units were installed in geometric arrays by the FloWind Corporation in California mountain passes.

Two other vertical axis gyro mills, which utilized slender high aspect ratio panemones, were of special interest to the present inventor. The McDonnell-Douglas model apparently never traveled beyond the St. Louis' aircraft manufacturer's on site wind tunnel.

The second normally vertical oriented device, quite similar in form to the McDonnell-Douglas model, was designed by M.I.T graduate student Herman Drees with the assistance of a private grant. Utilizing a plurality of extension springs to control panemone angles in either axis, the student was later granted U.S. Pat. No. 4,180,367 dated 25 Dec. 1979.

A DOE grant of $365,000 was awarded the Pinson Energy Corp., organized by the student inventor, to pursue the development and manufacture of a 4.5 meter orbiting diameter design rated at 4 kW in a 30 mph wind stream. In a volume entitled “Windpower” by V. Daniel Hunt issued in 1981 the said patented invention of Mr. Drees was claimed to have even greater efficiency than the Darrius rotor. Twenty units were reported to have been set up and tested in the Cape Cod, Mass. area but any record of the continuation of the company cannot presently be found.

Soon after the above essay was distributed, I was made aware of yet another innovative proposal which was not addressed in the Popular Science magazine. It was published in the Winter, 1978 edition of NASA Tech Briefs. Dr. John Paulkovich, an employee of the Goddard Space Flight Center, proposed a conceptual device utilizing synchronously geared panemones in a manner somewhat similar to the way I had previously discovered. Although Paulkovich did not mention the said Pascalian Limacon in his brief proposal, he did enumerate a portion of the inherent characteristics which I had discerned during my construction of the 4.5 inch miniature model some six months previously. From the author's simple illustration I did find it hard to fathom how the gear train was intended to extend from the central axis of a wheel to the orbital diameter of a plurality of paddles several meters distant.

Rather than being personally depressed by this disclosure I was elated to read about some of the same inherent properties I had discussed with the management of my own industrial employer. My discovery of these traits, and the opportunities they presented for new commercial products, some of which could be entirely unrelated to wind energy absorption, were whimsically derided by my employer. In spite of the rejection by my superiors, this proposal of Paulkovich was reassurance to me that my mode of thinking was on the right track.

My reaction was that Dr. Paulkovich's proposal would almost certainly be accepted by his NASA superiors or Department of Energy officials. I felt I would be completely overcome by the technical and financial resources that NASA and DOE commanded. So I believed it necessary to divert my attention to development of other conjunctive uses for said planar curve motation coupled with new inching motion technology which my research efforts had opened.

Near the end of this eight plus year period of concentration on conjunctive devices I realized I had not seen any reference to development or progress regarding the 1978 Paulkovich proposal in various journals devoted to technology. My efforts in late 1987 and early 1988 to contact the author through written correspondence were not answered. I then proceeded to contact our Congressional District Office. The Washington staff made personal contact with Dr. Paulkovich at the Goddard Space Flight Center. The staff of our Congresswoman of the time was assured that the NASA employee's published ideas were conceptual; that no inquiries came to him as a result of the published Tech Briefs article and, to his knowledge, the conceptual ideas he had presented were never reduced to practice.

It was absolutely amazing to the present Aged Tinkerer that evidence, presented by one of their own employees, of inherent exploitable characteristics in a basic energy gathering system, different from the technology they had chosen, would be completely ignored by U. S. governmental officials.

Return to Focus on Primary Goal

At this point in 1988 my work on developing advanced technology for exercising machines and wheelchair locomotion was put aside so that I could again pick up the many details of said Limaconic motation control and the configuration of structures for fluid stream energy absorbers. Incremental modeling continued for a few years in order to envision the variety of shapes and forms that the inherent features provided to address specific tasks. Near the end of that period in time, a vertical axis configuration appeared to best provide this opportunity.

One of the essential indispensable components emerged as a gearing system designed to control the angular relationship of a plurality of panemones in orbital reverse motation about a polar axis. Since I was unable to find any patented commercial products or patented teachings available to control the said unique limaconic motation, several years were consumed in testing devices constructed from cogged belts, pulleys, chains, cams and flexible shafts, etc. in order to judge their practicality in transferring rotation from a polar axis to a relatively distant radial position.

A structure fashioned mostly with plywood, which in appearance, was shaped like a spool, was controlled by miter and bevel gear sets well hidden within the architecture. The said spool and supporting framework was mounted on a trailer. Given the name “Quixote's Demon Strator.” It served a dual purpose of confirming the notion that energy absorption efficiency could be directly measured as the ratio between wind speed and the orbiting velocity—as well as attracting the interest from a few alternative energy supporters. This rather weighty prototype, pulled at a variety of steady speeds up to 25 mph, surprisingly registered an unloaded efficiency ratio between 35% to 40%. Finally the said Aged Tinkerer had developed a clumsy method based on the use of multiple angular axis gear trains for the purpose of controlling said angular relationship.

Counsel advice was to file an application for a proprietary patent for at least a motion control device and to incorporate as a legal entity for the purpose of personal protection. U.S. Pat. No. 5,509,866 for “Epicyclical Galactic Cluster Gearing System” was issued to the present inventor on Apr. 23, 1996.

During the last four years of the 20^{th} century the said patent well served its purpose in a series of prototype models constructed from recycled products and environmentally tested in order to judge the reliability of each of the installed ancillary mechanical components designed to absorb wind energy, or to emit the focused power of a pneumatic or hydraulic stream. The prototypes were titled “Fluid Stream Energy Weals”

This prolonged series of tests provided evidence of two facts: First it became clear that working appliances for absorbing wind or flowing water energy utilizing said Limaconic Motation Technology could be constructed in a multitude of configurations so as to meet particular environmental conditions.

Secondly, field testing of prototype models reinforced the realization that several of the accessory component devices required for operation of the present invention embodiments can also be fitted with a variety of tools and then utilized in an array of industrial, recreational, agricultural and transportation tasks such as mowing, chipping, shredding, mixing, blending, grinding, polishing; in human exercising; in manual marine propulsion and, plausibly, in wheeled terra locomotion and on vertical lift and landing aircraft. A large portion of these tasks are unrelated to the absorption or emission of fluid stream power.

Evaluation of Technology in Present Use

Over recent years several tours of in situ installation have been made by the Aged Tinkerer. During a March 1997 tour of southern California, western Minnesota and Northern Iowa, the present inventor gathered lengthy panoramic camcorder images of various wind energy gathering stations.

As the town of Mojave was approached from the south, our initial recordings revealed a depressing scene. More than one thousand “daisy wheels” were standing motionless above their supporting stems on a slowly descending slope viewed on the western horizon. Then, after turning west along route 58 en route to Tehachapi, scores of the of the famous “egg beaters’ provided another display of apparent disaster—not even one troposkein hoop could be recorded in a spinning mode! It was later found out that they had been shut down for safety reasons because of an unfortunate choice of structural material. Stress cracking had begun to develop in the aluminum blades. Bankruptcy protection was filed by FloWind Corp. just four months later.

A mixture of both success and failure was imaged along the view looking south from Route 58. A few invigorating installations were intermingled with apparently abandoned sites. The same mixture was evident along state road 202 while traveling near the Pacific Crest Scenic Trail.

Of the more than eight thousand units at the Tehachapi mountain station, less than one-third could have been producing electric power on that day in late March 1997. This mass display of specialized and highly complex turbines mounted at the apex of tall, and dangerous, towers seemed to the present inventor to represent very strange economics. To remain operable, intricate machines, require a necessary periodic maintenance regime.

It also seemed to the present inventor that this “Tehachapi Catastrophe”, at the very least, ought to expose the Economics of Complexity to vigorous inter industry debate

In Minnesota, at a relatively new three year old station near Lake Benton, late winter fog obstructed a clear view of an installation of seventy three Micon units. However, 20% of the viewable units were not rotating.

At the Iowa border near Sibley, three out of four refurbished Windmatic units were not productive but a nearby late model Micon, mounted atop a 150 ft. tower, was a welcome site. However. four months after my visit to that Iowa site, a very unfortunate accident occurred. While in the process of installing a 600 kW generator at the top of a second tower for a Micon unit, the engine of the lifting crane stalled, the crane became mired in soft soil, the load atop the crane became unbalanced and tilted over. A construction worker fell to the ground and was fatally injured in the accident.

At a small wind turbine manufacturing site near Prior Lake, Minn., two display models mounted just outside the factory were not spinning in a Beaufort 3 to 4 breeze.

Upon returning home in April 1997 from this private educational tour of wind turbine sites I was made aware of a publication by American Wind Energy Association director Paul Gipe. Entitled: “Wind Energy Comes of Age” (© 1995 John Wiley and Sons) the author quotes some relevant comments from various industry leaders regarding the intractable dilemma of almost total dependence on airfoil blade technology to absorb wind energy.

Then again, during the mid summer of 2005, the present inventor was accompanied by a second Elderly Tinkerer on a visit to an impressive field of some fifty-three Gamesa Eolica units recently installed near the town of Compton in northern Illinois. Still, it was in passing strange, to video record six of the absorbing propellers (about 11%) that were not rotating.

This Aged Tinkerer's personal assessment is that the following listed problems (a) to (g) are simply inherent to airfoil propeller based wind energy absorption installations:
(a) Dangerous and uneconomic procedures are required for both original installation and for providing regular maintenance.
(b) The stationary structure within the wind stream creates a “Tower Shadow Effect” and contributes to the generation of objectionable reverberating noise or electronic interference.
(c) Lengthy cantilevered blades require a very complex airfoil shape and expensive reinforcement to withstand the micro gusts within the incoming circular wind stream.
(d) Propellers must generate a tip speed ratio nearly six times greater than wind speed in order to efficiently produce electric power output.
(e) The resulting high blade tip velocity endangers avian wildlife.
(f) Overall efficiency is limited to a range of approximately 40% up to a questionable 50%.
(g) Widespread aesthetic objections infuriate citizens because it is nearly impossible to provide any semblance of artistic culture.

However, two additional problems seem to be rooted in a policy of conventional thinking.
(g) A plethora of electronic devices to control the complex inter activity of propeller tip speed with wind speed fluctuations and constant power output are required.
(h) The absorbed mechanical energy from each airfoil propeller, mounted at the apex of a high tower, cannot easily be fed to a compounding shaft which would then supply a single large electrical generator so as to more evenly balance the flow of electrical power.
(i) Minimal thought has apparently been given by then current windmill suppliers to the use of rotating power compounding shafts. Nor has it been given to the plausible notion of transferring propeller output power to driving pneumatic pumps (rather than directly to generators of electricity) so as to elevate pressure to appropriate levels in caldarium storage tanks located within the tubular supporting structure—and then drive electric power generators.

After completing a lengthy review of the serious technology and policy problems facing the wind power industry in the final years of the 20^{th} century the Aged Tinkerer's efforts during the following decade turned to the construction of a long series of small prototype models of the various components that the said Limaconic Motation technology would require. The resulting commercial style of said Fluid Streem Innergee Absorption Spheres may be utilized not only to efficiently capture wind energy but also harness the energy sources in rivers, ocean tidewaters and perhaps canals.

In addition the notion of utilizing Limaconic Motation for emitting a focused high velocity stream of fluid power was also tested with success.

Advantages of Limaconic Motation Technology

To provide a modular Energy Wheel Assemblage which can structurally support applications in a variety of geographic environments and be adapted to specific functions: Accordingly, aspects of various devices herein rendered as Figures for presentation with extant text come from the conceptual properties of the fluid stream energy absorption device or, inversely, from the focused power propulsion instrument.
1. Rotation of the designed Fluid Stream Innergee Absorption Sphere can be in either clock or counterclockwise direction; while at the same time the cranking motion of the said ALRID RecipVATAS component provides that the output power will always rotate in a single direction.
2. Mounting configuration can be omni-axis: vertical, horizontal or angular.
3. The wind velocity required for self start up of motation is dependent on the extent of bearing friction; the viscosity of lubrication; the total face area of panemones, and the measure of rotating mass.
4. The chordal axis of all of a plurality of panemones point to a common locus on the orbital diameter. Whenever the said chordal axis of one of a plurality of said panemones is located perpendicularly to an imaginary line tangent to the circular orbit, maximum energy is absorbed, or provides focused propulsion, by each of a plurality of said panemones passing through the point of tangency.
5. The reaction to both lift and drag forces are equalized in the unique phenomenon of said Limaconic Motation which results in a reactive orbital velocity less than the fluid stream speed while producing very high rotation torque—the level of said torque being dependent on the chosen orbital diameter.
6. A plurality of at least five rotating panemones can be enclosed within external and internal shaped chamber walls so as to create alternating vacuum and pressurizing chambers for gaseous fluids.
7. A plurality of controllable vectored fluid stream energy wheel assemblages plausibly could be utilized as power emitting components of vertical take off and landing aeronautical craft.
8. The present said Fluid Stream Innergee Absorption Sphere (sic. FSIAS) has been designed to link the rotary power output of linear strings of in situ units so as to drive a closed storage caldarium in order that the entropy of electric power generation to grids may be simply controlled.
9. Said FSIAS appliances can be reasonably designed for emplacement at the summit of many tall structures:—apartment and office buildings; community water towers; agricultural silos; parking lot illumination poles; residential buildings on open land; as well as in large lakes and rivers.
10. One aspect of the current patent application; said panemones are anchored and secured at opposing extremities and therefore eliminate the stress problems presented by cantilevered blades.
11. Said panemones may be designed in a variety of configurations as well as being molded of inflatable material thereby easily responding to stress.
12. Said panemones can display regulating means that possess, to some extent, properties that are similar to wings, rudders and blades of aircraft.
13. Aspects of the said “Epicyclical Hybrid Gearing Control System” provide the means of precisely controlling the angular relationship of a plurality of said panemones in orbit about the polar axis of said FSIAS.
14. Said EHGCS provides for the generation of a plurality of simultaneous planar curves.
15. Said EHGCS provides means of allowing multiple output rotations to simultaneously be in opposing rotations and generate differing velocities.
16. Said EHGCS provides for an increase in the capacity of production units by means of being installed in both north and south poles of said FSIAS.
17. Said EHGCS provides a simple means of instant response to variations of both wind direction and velocity.
18. Said EHGCS provides nontroubling maintenance accessibility when installed within the tubular body, or barrel like polar axis, of FSIAS.
19. Said EHGCS provides a mechanism which can be activated in two different modes: First, by grounding the #207 Polar Axis Pinion Gear while urging the rotation of #201/203/204 Enclosure Casing; or secondly, by grounding the said Enclosure Casing and urging the rotation of the said #207 Polar Axis Pinion Gear.
20. Said EHGCS provides a mechanism in which the said Polar Axis Pinion Gear and the said Enclosure Casing can be urged to simultaneous rotation at differing velocity rates. This particular property may be utilized as a coded signaling device.
21. The application of said ALRID RecipVATAS aspect (which is based on the attributes of the Lemniscate planar curve of Bernoulli) provides for an appropriate device to accelerate the intended low rotary output velocity of said FSIAS while at the same time providing capability of accumulating the high torque emitted by a linear train of companion FSIAS emplacements.
22. A variety of power storage means; i.e. hydraulic, pneumatic or thermal, may be clutched into said ALRID RecipVATAS devices which will protect against over speeding an electrical generator during extreme surges of speed from oncoming wind streams
23. Said ALRID RecipVATAS can be utilized for a variety of applications: (1) hu-manual marine craft propulsion, (2) hu-manual wheeled propulsion on terra, (3) human cross training and exercising, (4) hu-manual generation of said THEMP power.

### SUMMARY

It is the conviction of the present inventor that many airfoil design engineers misconcentrated their abilities by trying to squeeze every bit of rotational tip speed out of propeller type wind energy absorbing mechanisms. The result has been catastrophic stressing, costly vibration, electronic static interference and reverberating noise problems caused by tower shadow. Many installation and maintenance procedures at the apex of tall towers is both expensive and demonstrably dangerous. The wounding and destruction of avian wildlife has further engendered public objection and distrust.

We hold the belief that the relatively slow speed of Limaconic panemones within the energy absorption appliance will be found to have far greater operational efficiencies and be far less costly, dangerous and annoying, than the use of airfoil propeller technology.

As acceptance and use of the unique Limaconic Motation (Lim-a-Mota) technology as a popular means of translating natural renewable energy into THEMP powered devices increases, a multitude of design variations for some of the components ought to be encouraged to develop further in order to meet presently unrealized challenging environmental conditions.

Ancillary Research Data Which Provides Comprehension of Planar Curve Aspects.

Comp. A is an illustration of formulations for calculating the particular size and configuration of said Limacon planar curve.
Comp. B is an illustration of movement of the locus point in an orbital circle in relation to the direction of the urging force.
Comp. C is a copy of an article entitled: “Wind/Water Energy Converter” by said Dr. Paulkovich in NASA Tech Brief, Winter 1978.
Comp. D is a copy of pp. 84 from Time LIFE Science Library volume entitled “Mathematics” published circa 1963.
Comp. E is a copy of internal cover page of said “Mathematics” volume. Comp. F-1; F-2; F-3 is a copy of a personal letter addressed to said Dr. Paulkovich dated Mar. 31, 1988.
Comp. G is a copy of a Voith-Schneider, Gmbh, advertisement published in circa 1960 regarding a “Squirrel Cage Propeller” utilized in tugboats.
Comp. H is a copy of an editorial entitled: “Wind's Wildlife Challenge,” which appeared in March 2004 issue of Windpower Monthly magazine.
   List of Reference Numerals

(Note: The following list includes numerals assigned to individual parts; to sub-assembly and full assembly components; and to titles regarding aspects of Empirical Research Devices.

| E.R.D. | |
|---|---|
| # 20 | Fluid Streem Innergee Absorption Sphere (FSIAS). |
| # 50 | Panemone Component for Installation in Fluid Streem Innergee Absorption Sphere |
| | and in Focused Power Emission Sphere. |
| # 200 | Epicyclical Hybrid Gearing Control System (EHGCS) for Generating both Limaconic |
| | and Simultaneous Clusters of Other Planar Curves. |
| # 300 | Reciprocating Inching Device to Provide Velocity Acceleration and Torque Accumulation |
| | to revolving output Shafts. (ALRID RecipVATAS) |
| # 400 | Katamaran Kanew design utilizing Focused Limaconic Orbiting Waves (FLOW) |
| | emitted by #275 Nautical Propulsion Instrument which can be |
| | enabled by #375 Asynchronous Armsand Legs Humanual Engine. |
| | is included to demonstrate just one of a multiplicity of new products that can |
| | emerge from Limaconic Motation technology. (KatKanFLOW) |

| Number | Nomenclature | E.R.D. use |
|---|---|---|
| 10 | Erected arms structure of twin radial wheels | 20; |
| 11 | Polar barrel | 20; |
| 12 | Tubular radial arm | 20; |
| 13 | Structural bracing channel | 20 |
| 14; 14a | Flat links | 20; |
| 15 | Plurality of Fastening pins | 20; |
| 16 | Slidable collar | 20; |
| 17 | Roller thrust bearing | 20; |
| 18 | Rotational erection nut | 20; |
| 19 | Anchoring ball for attaching right angle drive | 20; |
| 20 | Fluid Stream Innergee Absorption Sphere | |
| | (components identified in FIG. 4 and FIG. 5) | |
| 21 | Interlocking hemispheric dome segments | 20; |
| 22 | Latching bar for dome segments | 20; |
| 23 | Threaded Fastening means | 20; 90; 200; 245; 400 |
| 30 | Polar axis spacer | 20; |
| 31 | Central coordinating rod | 20; |
| | (from North Pole control pinion to South Pole control pinion) | |
| 32 | Coupling sleeve | 20; |
| 33 | Mounting hubs for central axis spacer | 20; |
| 34 | Tubular spacer | 20; |
| 35 | Coil spring | 20; |
| 36 | Flanged bushing | 20; |
| 37 | Plurality of long keys (or alternate of hobbed splines) | 20; |
| 40c | Commercial standard type C right angle drive | 20; |
| 40g | Commercial standard type G right angle drive | 20; |
| 41 | Adjustable device for clamping right angle drive to anchoring ball #19 | 20; |
| 45 | Assembly of Tee Bar mounting component | 20; 50; |
| 46 | Tee bar and disc combination | 20; 50; |
| | (having external threading and pointed tips on disc facing) | |
| 47 | Malleable insert disc | 20; 50 |
| 48 | Clamping hub having pointed tips on facing | 20; 50 |
| 49 | Internally threaded closure ring | 20; 50 |
| 50 | Panemone Component | 20; 50; |
| 51 | Expanded and arched metallic sheets | 20; 50; |
| 52 | Longitudinal boots (2 per assembly) | 20; 50; |
| 53 | Flexible grooved covering | 20; 50; |
| 54 | Longitudinal clamping rods having internally threaded ends | 20; 50; |
| 55 | End cup stream guide/mounting channel (2 per unit) | 20; 50; |
| 56 | Tempered flat spring intimately fixed to Rod 54 | 20; 50; |
| 57 | Externally threaded bolts for fastening #54 longitudinal clamping rods | 20; 50; |
| 58 | Externally threaded bolts for locking #45 Tee Bar to #55 End Cap channel | 20; 50; |
| 60 | Commercial U-joint assembly (signified by X --- X) | 20; 100; |
| | intimately connecting distal #40 right angle drive to #200 hybrid | |
| | gearing control device installed within #11 polar barrel | |
| 70 | Output rotation bearing/crankshaft | 20; |
| 71 | Sleeve bushing, short | 20; |
| 72 | Output spur gear | 20; |
| 73 | Keys, locking (within bore) | 20; 70; 200; |
| 74 | Sleeve bushing, long | 20; |
| 75 | Crankshaft | 20; |
| 76 | Spur gear, velocity step up | 20; |
| 77 | Flanged sleeve bushing | 20; |
| 78 | Housing, lower proximate | 20; |
| 79 | Housing, lower distal | 20; |
| 80 | Housing, top cover | 20; |
| 90 | Commercial worm gear and stepping motor | 20; 200; 245; 400; |
| 100 | Horizontal axis mounting cradle sub assembly | 20; 100; |
| 101 | Anchored central table | 20; 100; |
| 102 | Anchored circular track structure | 20; 100; |
| 103 | Spring loaded ball transfer | 20; 100 |
| 104; 104a | Right angle (type E) gear assembly | 20; 100; |
| 105; | Mounting box | 20; 100; |
| 106 | Roller clutch drive | 20; 100; 300; 400; |
| 107 | Bridge structure | 20; 100; |
| 108 | Stanchion structure | 20; 100; |
| 109 | Caster wheels | 20; 100; |
| 110 | El clamping guide | 20; 100; |
| 200 | Epicyclical Hybrid Gearing Control device for generating planar curves | 20; 200; |
| 201 | Front cover plate | 20; 200; |
| 202 | Housing ring encasing pinion gears | 20; 200; |
| 203 | Mid plate | 20; 200 |
| 204 | Transition housing | 20; 200; |
| 205 | Sealing “O” rings (not shown) | 20; 200; |
| 206 | Facing gasket | 20; 200; |
| 207 | Polar axis pinion gear | 20; 200; |
| 208 | Idler pinion gear | 20; 200; |
| 209 | Orbiting pinion gear | 20; 200; |
| 210 | Miter gears | 20; 200; |
| 212 | Thrust bearing | 20; 200; |
| 213a, b | Spacing washers | 20; 200; |
| 215 | Flanged bushings | 20; 70; 200; |
| 218 | Grease seals | 20; 200; |
| 220 | Parallel axis gearing segment | 20; 200; |
| 221 | Threaded fastener (short) | 20; 200; 245; 250; 400; |
| 222; 222a; | Threaded fastener (long) | 20; 200; 245; 250; 400; |
| 225 | Angular axis gearing segment | 20; 200; |
| 228 | Panemone propulsion blade segment | 20; 200; |
| 230 | Radial shaft assembly | 20; 200; |
| 231 | Radial shaft | 20; 200 |
| 232 | Ball bearing (minor) | 20; 200; |
| 233 | Ball bearing (major) | 20; 200; |
| 234a, b | Spacing washers | 20; 200; |
| 235 | Thrust bearing | 20; 200; |
| 239 | Flat gasket (not shown) | 20; 200; |
| 240 | Mounting cap | 20; 200; |
| 245 | Focused fluid power emission device (or instrument) | 400; |
| 250 | Carrier box for Focused fluid power emission device (or instrument) | 400; |
| 252 | Structural braces | 250; 275; 400; |
| 253 | Brace plate | 250; 275; 400; |
| 254 | Support plate | 250; 275; 400; |
| 255 | Panemone type blades | 245; 275; 400; |
| 256 | Rotary plate | 245; 275; 400; |
| 257 | Central body structure | 250; 275; 400 |
| 258 | Carrier cap | 250; 275; 400 |
| 260 | Commercial right angle step-up drive | 250; 275; 400; |
| 261 | Driver spur gear | 250; 275; 400; |
| 262 | Driven spur gear | 250; 275; 400; |
| 264 | Thrust and radial bearing | 250; 275; 400; |
| 265 | Bearing means | 245; 250; 275; 400; |
| 275 | Focused Nautical Propulsion Instrument | 245; 250; 400; |
| 300 | Reciprocating Inching Device to Provide Velocity Acceleration | 20; |
| | and Torque Accumulation to Revolving Output Shafts. | |
| 301 | Slideable framework for anchoring gear racks | 20; 300; |
| 302 | Spur gear rack | 20; 300; 400 |
| 303 | Shim for controlling backlash | 20; 300; 400; |
| 305 | Guide rods | 20; 300; 400 |
| 306 | Bushing | 20; 300; |
| 310 | Stub gear-housing (with inserted roller clutch) sub-assembly | 20; 300; |
| 312 | Housing for combination of roller clutch and stub gear | 20; 300; |
| 313 | Roller clutch | 20; 300; |
| 315 | Inner race for roller clutch | 20; 300; |
| 318 | Thrust bearing | 20; 300; |
| 318a | Spacing washers | 20; 300; |
| 319 | Sealed bearing | 20; 300 |
| 320 | Output shaft | 20; 300; |
| 322 | Rocker arm | 20; 300; |
| 323 | Rolling pin | 20; 300 |
| 324 | Retainer ring | 20; 300; |
| 326 | Flat head fastener | 20; 300; |
| 327 | Locking screw for rack shims | 20; 300; |
| 328 | Threaded fastener for gar racks | 20; 300; |
| 329; 329a | Grease Seals | 20; 300 |
| 330 | Roller bearing | 20; 300; |
| 331 | Splined coupling | 20; 300; |
| 332 | Internal snap ring | 20; 300; |
| 333 | Encasement box | 20; 300; |
| 334 | Flat sealing gasket (not shown) | 20; 300; |
| 335 | Encasement cover plate | 20; 300; |
| 336 | Grease retaining boot | 20; 300; |
| 340 | Crankshaft clamp sub-assembly | 20; 300; |
| 341 | Extension shaft | 20; 300; |
| 342 | Expansion screw | 20; 300; |
| 343a; 343b | Clasping clamp pair | 20; 300; |
| 344; | Leverage pin | 20; 300; |
| 346 | Retaining ring | 20; 300; |
| 350 | Assembly of components for in situ vertical axis installation of #20 FSIAS | 350; |
| 351 | Commercial antenna communication means | 350; |
| 352 | Multi arm structural frame for vertical axis installation of a plurality of #20 FSIAS | 350; |
| 355 | Commercial container, or caldarium, for storage of thermal, hydraulic or pneumatic | 350; |
| | power as an alternate means before releasing to drive an electrical generator | |
| 360 | Slideable dual framework for intimately attaching multiple gear racks | 400; |
| 361 | Alignment dowel | 400; |
| 362 | Pinion gears | 400; |
| 363 | Double row bearings | 400; |
| 364 | Quarter gears/shaft combination | 400; |
| 365 | Anchored encasement | 400; |
| 366 | Facing covers | 400; |
| 367 | Splined extension shafts | 400; |
| 368 | Threaded bushings | 400; |
| 370 | Internal retaining ring | 400; |
| 371 | Bronze bushings | 400; |
| 372 | Roller bearings | 400; |
| 373 | Alignment shaft | 400; |
| 375 | Armsand Leg's HuManual Engine | 400; |
| 381 | Parallel arms lifting apparatus | 400; |
| 382 | Parallel asynchronous curved motion rods | 400; |
| 383 | Upper torso handle bars | 400; |
| 384 | Lower torso pedals | 400; |
| 385 a, b | Pivoting suspension drive assemblies | 400; |
| 386 | Commercial free swinging suspension pivots | 400; |
| 387 | Adjustable seats | 400; |
| 390 | Hull framework | 400; |
| 392 | Dual pontoons | 400; |
| 400 | Katamaran Kanew (possessing Limaconic propulsion means enabled by asynchronous | |
| | humanual effort) | |

### BRIEF DESCRIPTION OF DRAWINGS

For reasons of clarity a plurality of two, three or four radial gear trains, or panemones, are shown in views of the various embodiments.

FIG. 501 is a schematic polar axis layout which exhibits the unique aspect of the Limacon planar curve by demonstrating progressive angularity of a plurality of panemones being urged to orbit in counter-clockwise direction at one half velocity about the central axis of a fixed pinion while the supporting control gears are rotating at full velocity in a clockwise direction

FIG. 502 is a cross sectional view of the completed embodiment of Fluid Stream Innergee Absorption Sphere sub-assemblies together with the required horizontal axis mounting cradle.

FIG. 503 is a cross section view of a Fluid Stream Innergee Absorption Sphere sub assembly #10 in a retracted position for shipping and installment operations.

FIG. 504 is a cross sectional view of a polar wheel sub-assembly in erected position.

FIG. 505 is a cross sectional view of a polar axis spacing sub-assembly with internal coordinating rod emplacement.

FIG. 506 is an enlarged cross sectional view of the Output Rotation Crankshaft sub-assembly.

FIG. 507 is a cross sectional view of a horizontal axis Mounting Cradle sub-assembly.

FIG. 508 is a cross sectional view of an unmounted Bipolar FSIAS.

FIG. 509 is a perspective view of basic #352 fixed framework required to mount a plurality of FSIAS in vertical orientation as well as component sub-assemblies.

FIG. 510 is a perspective view of a covering attached to the basic structural framework of previously shown FIG. 501 by which fluid flow is enhanced; on which solar ray coatings, or panels, may be installed; and human artistic preferences may also be satisfied by its contour.
(for the sake of clarity in this rendering the radial support arms and devices in place within the hemispheric bowls are not shown)

FIG. 511 is a cross section view of the assembled embodiment of an Epicyclical Hybrid Gearing Control System for generating Limaconic and simultaneous clusters of other planar curves.

FIG. 512 is an expanded perspective view of the individual components of the said embodiment of EHGCS.

FIG. 513 is a gear train layout which depicts a lesser pitch diameter pinion emplaced in the polar axis position while the greater pitch diameter pinion is emplaced in the orbital position.

FIG. 514 is a gear train layout which depicts a greater pitch diameter pinion emplaced in the polar axis position while the lesser pitch diameter pinion is emplaced in the orbital position.
(Note: Only the position of the bearing bores supporting the idler pinion gear in the End Plate #201 and the Mid Plate #202 need revision in the present EHGCS device.)

FIG. 515 is a cross sectional view of the #11 Polar Barrel component of the FSIAS which shows the accessible installed position of the #200 EHGCS within the said Barrel,

FIG. 516 is a cross sectional view of a modification of FIG. 511 depicting #225 Angular Axis Gear Segment being removed and replaced by #255 panemonic type propulsion blades and #226 rotary plate therefore being identified as sub-assembly #245 Focused Fluid Power Emission Instrument.

FIG. 517 is a cross sectional elevated view of Carrier Box for supporting #245 focused propulsion implement.

FIG. 518 is a cross sectional plan view of Carrier Box for giving support to #245 focused propulsion implement

FIG. 519 is a cross sectional elevated view of an #245 Focused Power Emission Instrument inserted within #250 Carrier box therefore being identified as assembly #275 Focused Nautical Propulsion Instrument.

FIG. 520 is a perspective illustration of an assembled said #50 Panemone with the Mounting Device components #45 shown in a detached area (for reasons of clarity).

FIG. 521 is a perspective rendering of the constituent parts in the FIG. 520 illustration.

FIG. 522 is a perspective illustration of a #301 dual reciprocating frame for anchoring two adjustable offset gear racks.

FIG. 523 is a perspective rendering of the constituent pieces of #300 inching mechanism named said ALRID RecipVATAS based on the planar curve entitled “Lemniscate of Bernoulli” which can be mounted within an assortment of anchored housing means.

FIG. 524 is a cross sectional view of #300 inching mechanism assembled within an anchored enclosure; said inching mechanism being urged by #340 cranking rod to reciprocate, therefore cause #320 shaft to rotate in a single direction.

FIG. 525 is a perspective rendering of #360 dual framework for intimately installing a multiple of at least four gear racks in a manner so as to replace the said #301 framework as well as the #340 cranking rod activation means of the said #300 inching mechanism by installing an Asynchronous Humanual Arms and Legs means of actuation.

FIG. 526 is a cross sectional end view elevation rendering of a variation of the original said ALRID RecipVATAS device so as to create #375 appliance entitled “Armsand Leg's Humanual Engine”.

FIG. 527 is a cross sectional side view elevation rendering of a variation of the original said RecipVATAS device so as to create #375 appliance entitled “Armsand Leg's Humanual Engine”.

FIG. 528 is an elevated side view of #400 “Katamaran Kanew” proposal which serves as a demonstration of the fact that minor variations in several components of the primary PSIAS invention can be utilized in unrelated fields of commercial enterprise. Specifically, the original said #300 ALRID RecipVATAS device is the guide for the said #375 Armsand Leg's Humanual Engine while the said #220 parallel axis gearing segment of EHGCS is the escort for the said #245 Nautical Focused Power Emission Device which can be utilized in omnifarious military, industrial and domestics products.

FIG. 529 top view of the said #400 “Katamaran Kanew” proposal.

FIG. 530 is a perspective view of proposed #390 Hull Framework and the intimately attached #392 Pontoons which provides support for ancillary components.

What is claimed is:

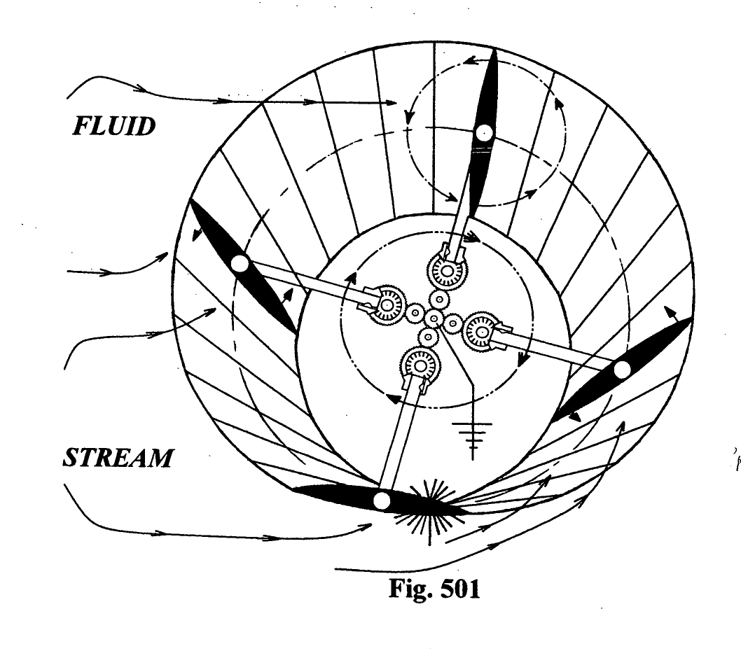

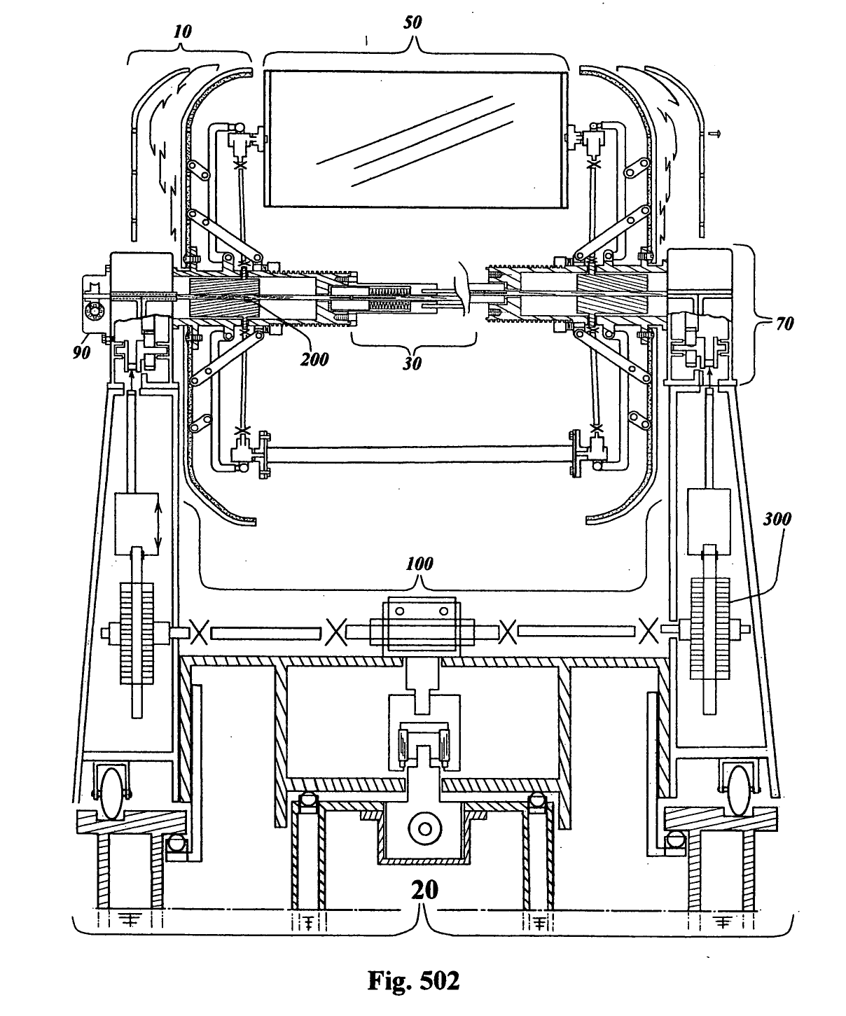

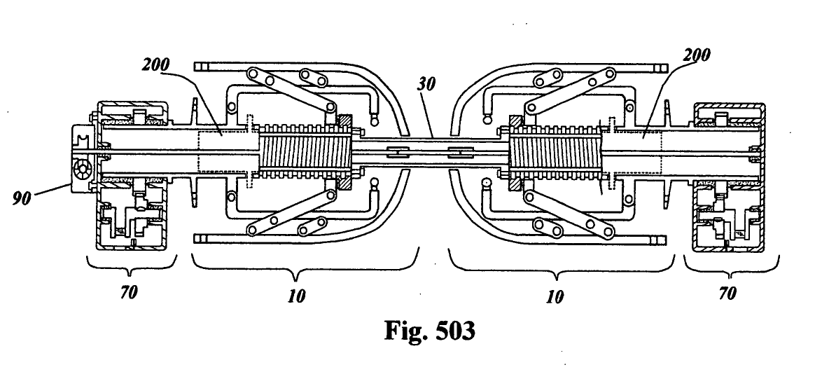

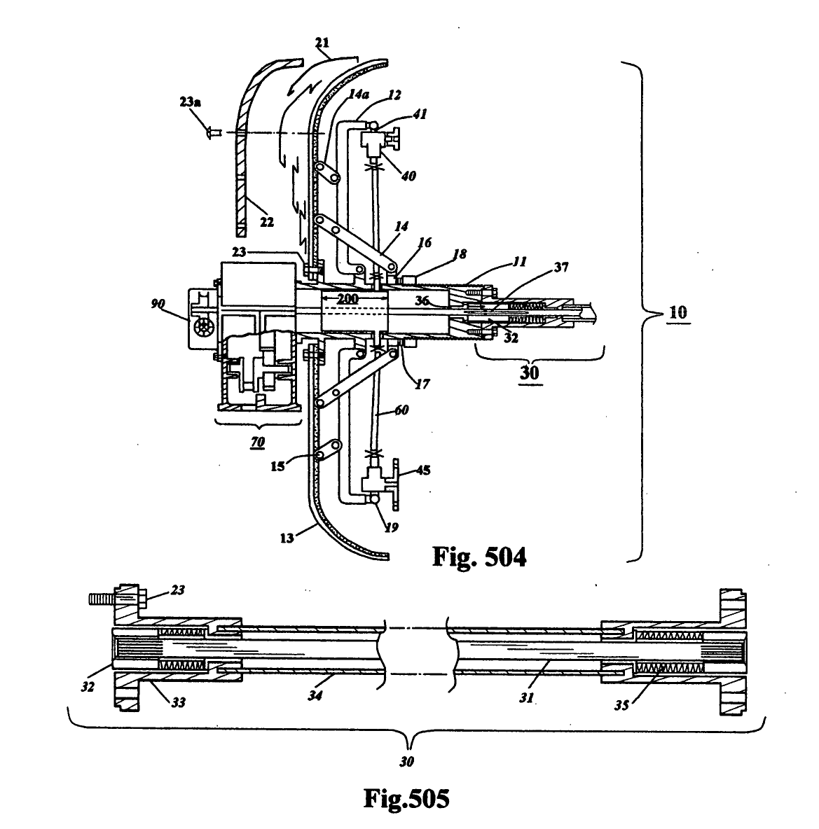

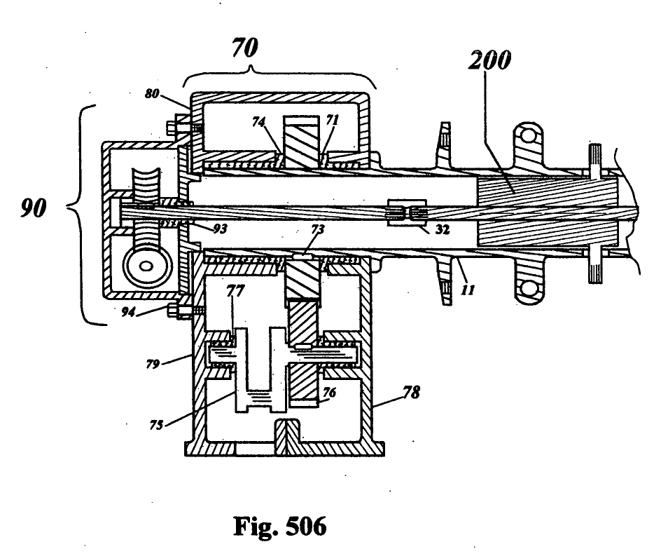

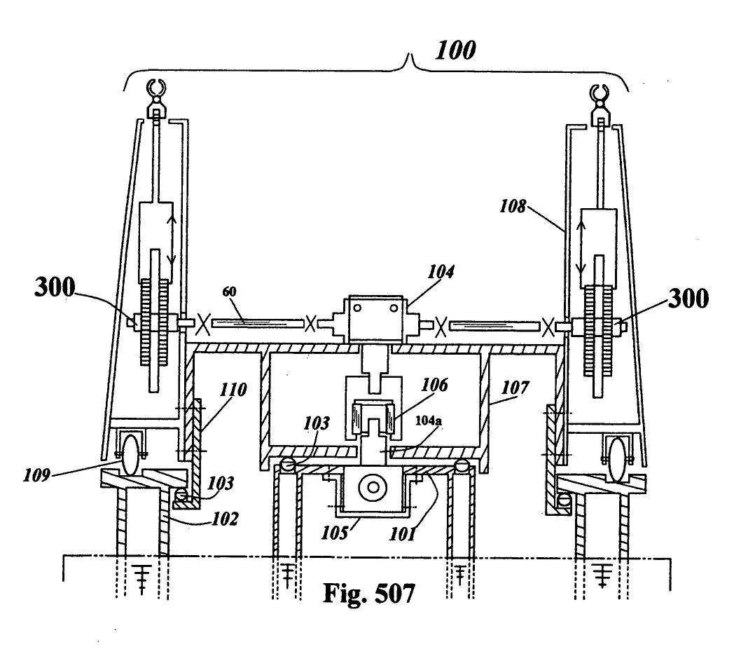

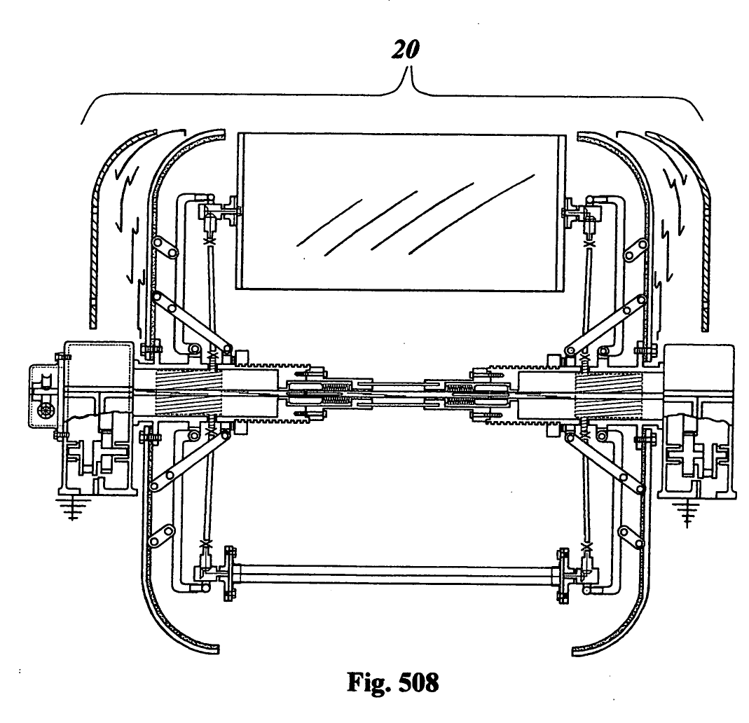

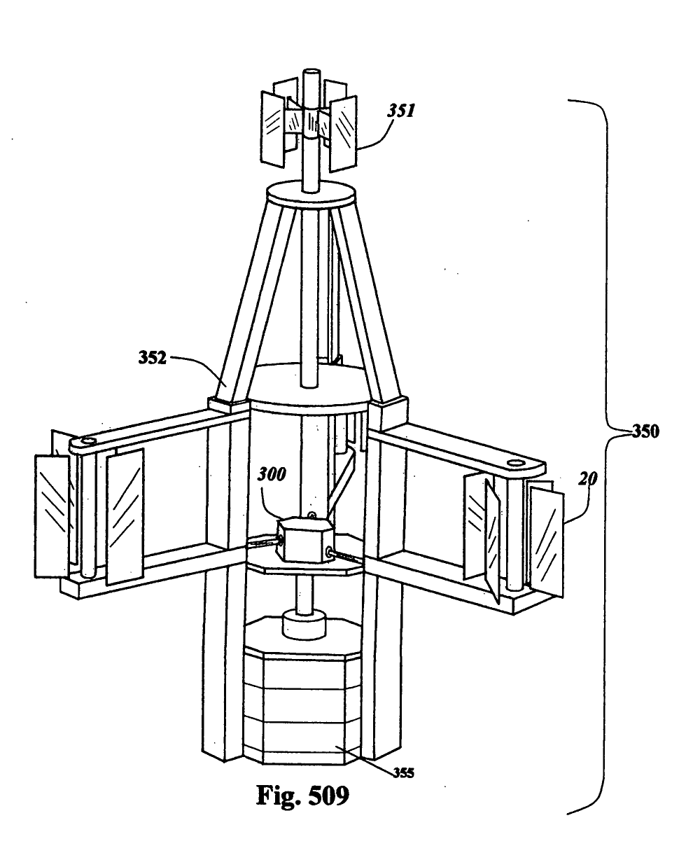

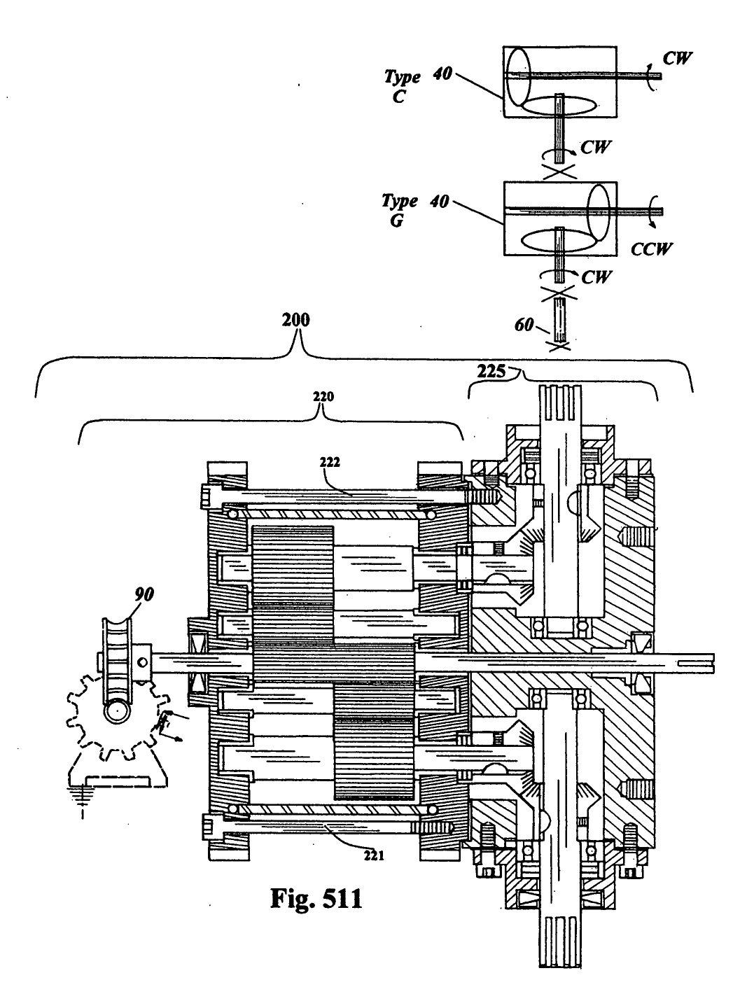

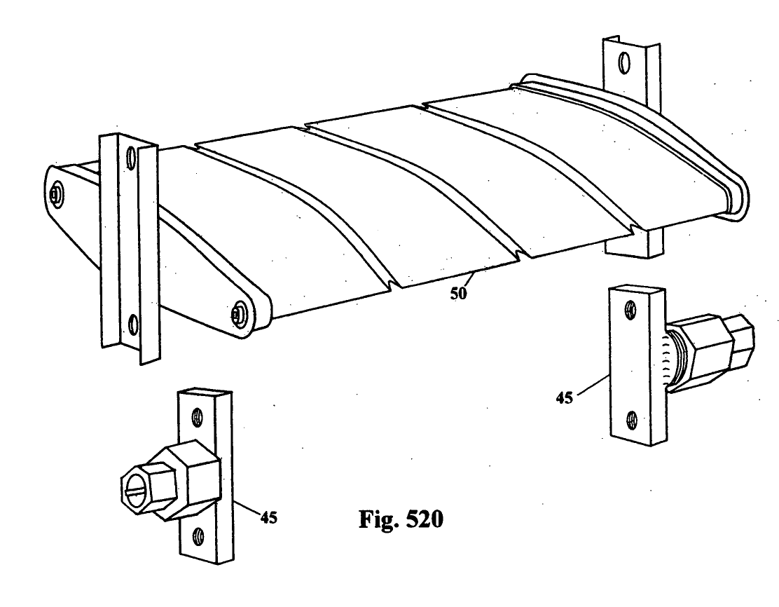

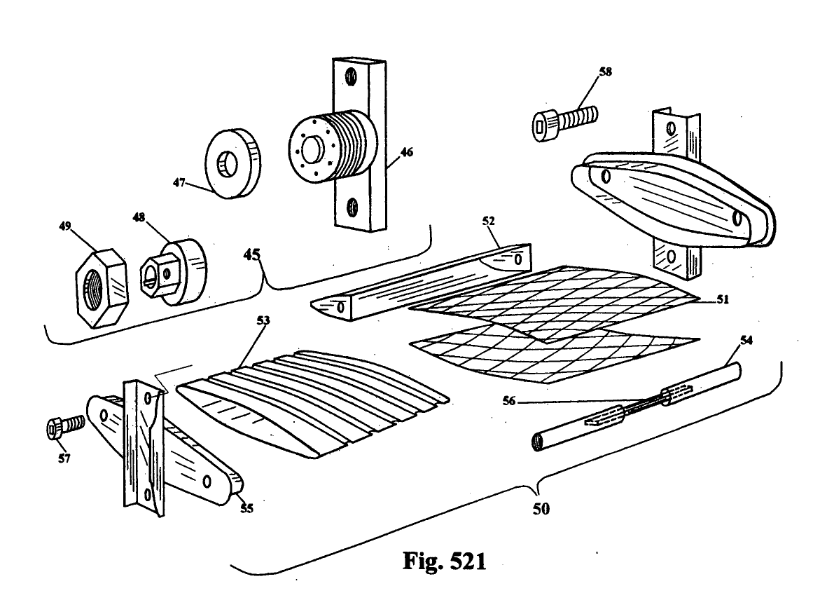

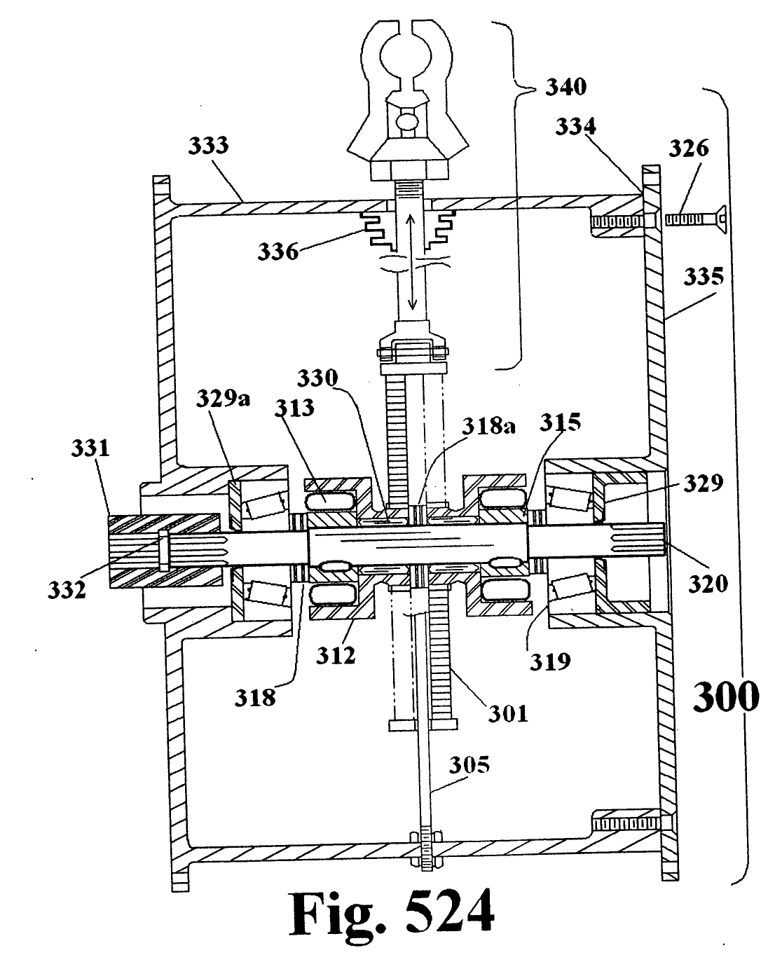

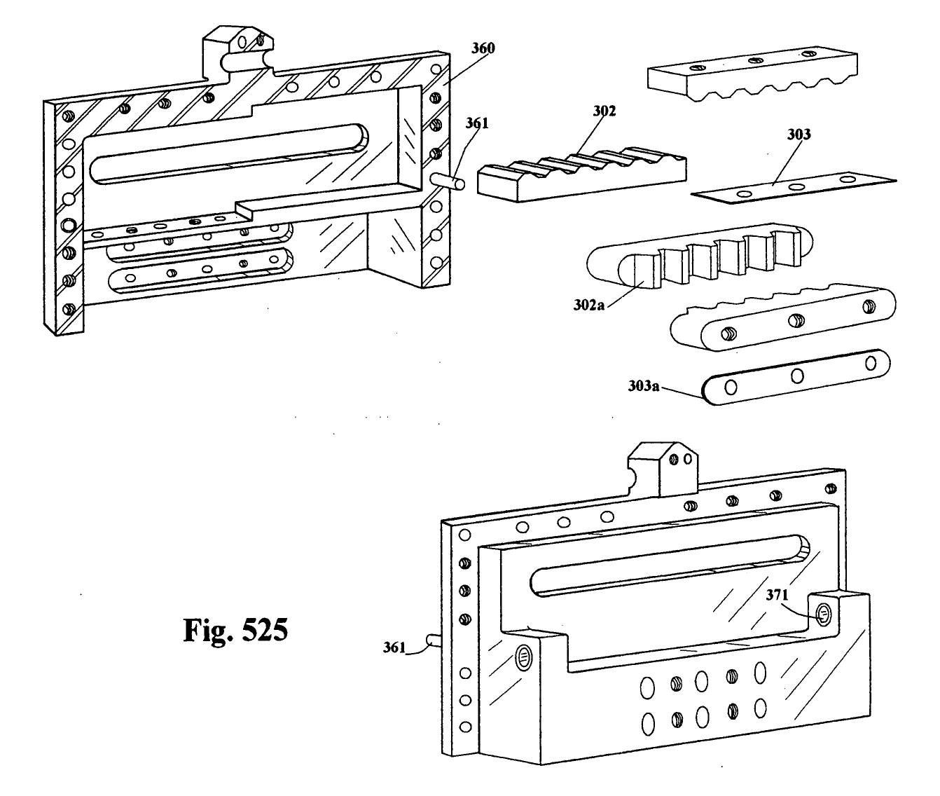

1. An apparatus of component devices assembled into a fluid streem innergee absorption sphere comprising;
two erected polar wheel sub-assemblies supporting a plurality of radial arms (#10-FIG. 504),
a polar axis spacer containing a coordinating rod (#30-FIG. 505;)
a plurality of panemone components (#50; FIG. 520; 521;)
a plurality of clamping devices for mounting said panemones (#45; FIG. 520;)
a single epicyclical hybrid gearing control system [EHGCS] sub-assembly for controlling the
rotating angular relationships of said plurality of said anemones (#200; FIG. 511;)
a horizontal axis cradle sub-assembly (#100; FIG. 507)
a single reciprocating velocity accelerator and torque accumulating shaft [ALRID RecipVATAS] system (#300; FIG. 524)
{all sub-assembly components assembled together are identified as [FSIAS] #20; FIG. 501}
whereby, the inertia of flowing gaseous or liquid streams is captured by the facing areas of said panemones so as to urge rotation of said erected polar wheel assembly, (#20; FIG. 508;)
thereby driving the said THEMP accumulation system.

2. An apparatus assembly as set forth in claim 1 wherein;
said EHGCS device #200 installation is increased to a plurality of two;
said ALRID RecipVATAS #300 is increased to a plurality of two,
whereby, the energy absorption capacity and projected service life of the said FSIAS is substantially increased.

3. An apparatus assembly as set forth in independent claim 1 and in dependent claim 2
wherein covering sheets are fixedly attached to the basic structural framework
thereby, providing means giving support to attainment of a smooth fluid flow as well as artistic satisfaction.

4. An apparatus as set forth in claim 3 in which implements for processing the energy of solar rays are fixedly attached to, or through, the covering sheets,
whereby, additional natural renewable energy is absorbed.

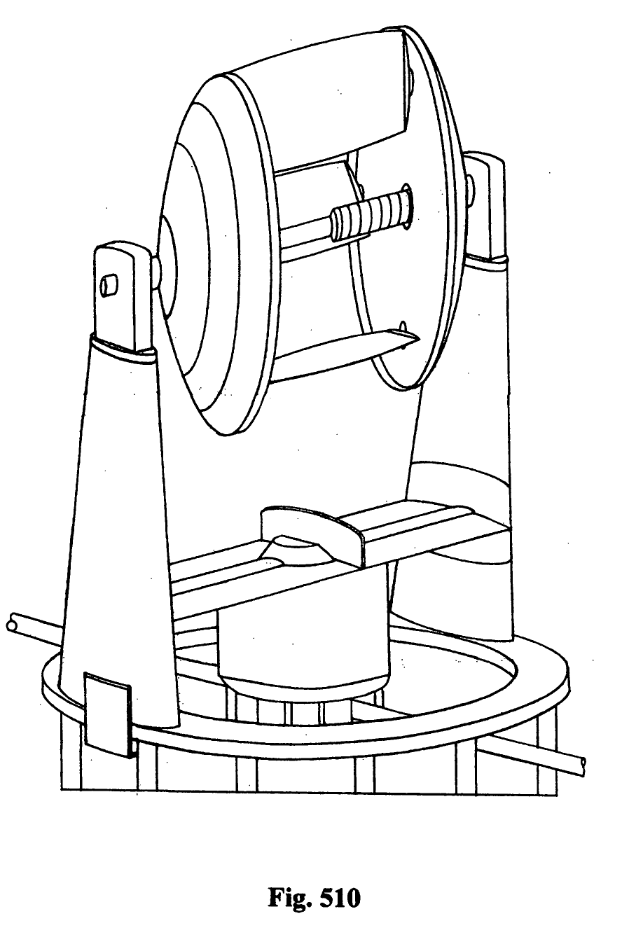

5. An apparatus assembly (# 350; FIG. 509) of component devices comprising:
a plurality of assembled fluid stream energy absorption spheres #20; FIG. 508);
cradling framework (#352) for installing said plurality of said fluid stream energy absorption spheres in a vertical polar axis position;
a plurality of reciprocating velocity accelerator and torque accumulation systems #300;
storage of thermal, hydraulic or pneumatic power as an alternative means of driving an installed electrical generator (not shown); an antenna means #351;
whereby, communication signals are received and transmitted from areas that are without access to an electric power grid.

6. An essential durable, yet flexible, paddle, panel, plate or vane comprising:
tee bar and disc combination having external threading and pointed tips on disc facing (46);
malleable insert disc (47);
clamping disc having pointed tips on facing (48);
internally threaded closure ring (49);
expanded and arched metallic sheets (51);
longitudinal boots (52);
flexible grooved covering material (53);
internally threaded longitudinal clamping rods (54);
end cup stream guide/mounting channel (55);
tempered flat spring intimately fixed to rods (56);
externally threaded bolts for fastening longitudinal clamping rods to end cup stream guides/mounting channel (57);
externally threaded bolts for locking tee bar to end cup (58);
whereby said components are fixedly assembled into #45 tee bar and #50 panemone (FIG. 520)

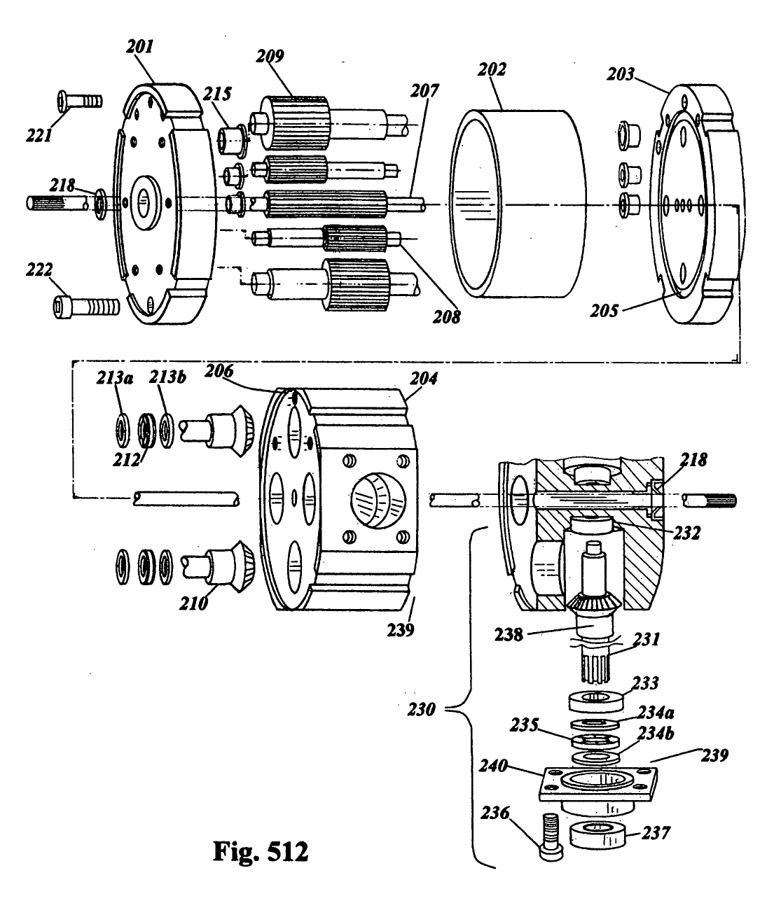

7. an epicyclical hybrid gearing control system (EHGCS) #200 having a progressive gear train ratio of size 1.0:1.0:2.0 from polar axis to orbital axis generating Limacon and Three Leaf Rose planar curves comprising:
front face flange #201;
size one polar axis pinion gear #207;
plurality of size one idler pinion gears #208;
plurality of size two orbital pinion gears #209;
sealing “O” rings #205;
pinion enclosure ring #202;
flanged bushings #215;
grease seals #218;
mid plate flange #203;
threaded fasteners—short #221;
thrust bearings # 212;
backlash adjustment washers #213a,b;
plurality of miter gears #210;
locking keys #238 (not shown);
flat sealing gasket #239;
miter gear enclosure #204;
threaded fastener—long #222;
plurality of radial shafting sub-assemblies #230—which are composed of the following elements:
radial shaft #231;
locking key #238;
miter gears #210;
ball or roller bearing #232;
ball or roller bearing # 233;
thrust bearing # 235;
backlash adjustment washers # 234a,b;
flat sealing gasket # 241;
mounting cap #240;
grease seal # 237;
threaded fasteners # 236;
commercial U-joint assembly #60;
right angle drive #40C or 40G;
commercial worm gear set and stepping motor #90.
Whereby, desired rotational relationships of blades, paddles, panels, tools or vanes are precisely controlled when utilized in various mechanical tasks. (FIG. 511 and FIG. 512)

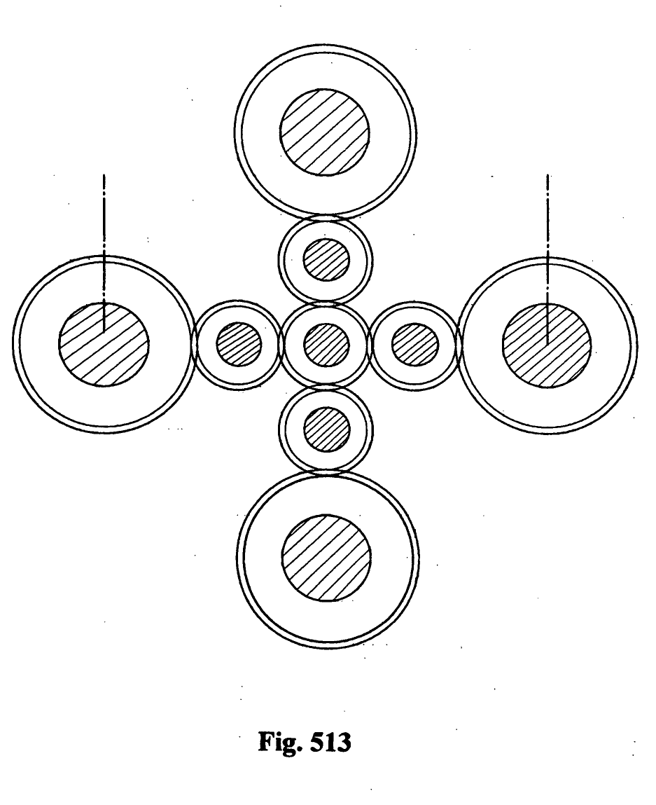

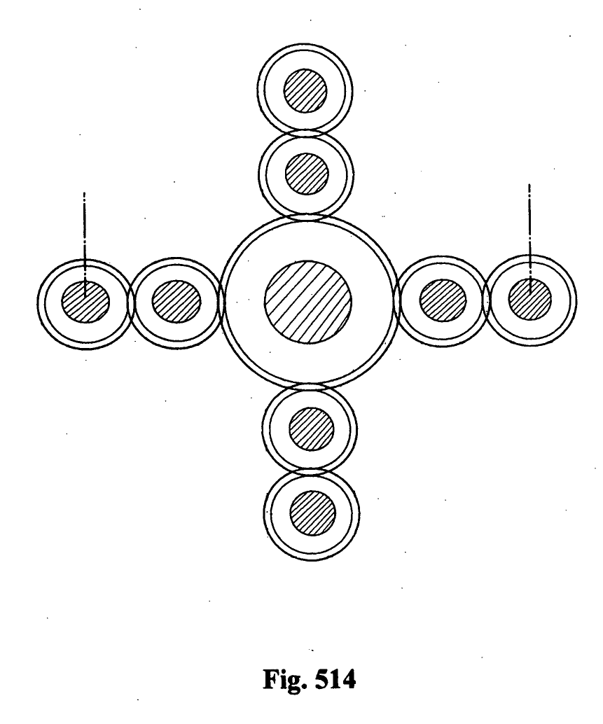

8. A #200 EHGSC assembly having a revision of spur gear ratios in each of the progressing radial trains are varied, beginning at the polar axis to the orbital axis, from a velocity regression of 1.0:1.0:2.0 into a 2.0:1.0:1.0 progression,
Whereby, generation of a multiplicity of yet unnamed planar curves reaching higher output velocities is utilized for a variety of industrial and agricultural tasks. (refer to FIG. 513 and FIG. 514)

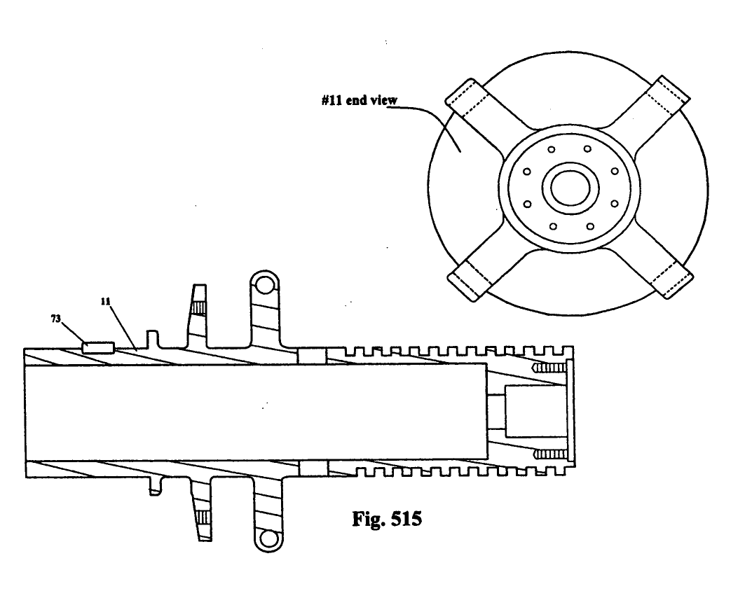

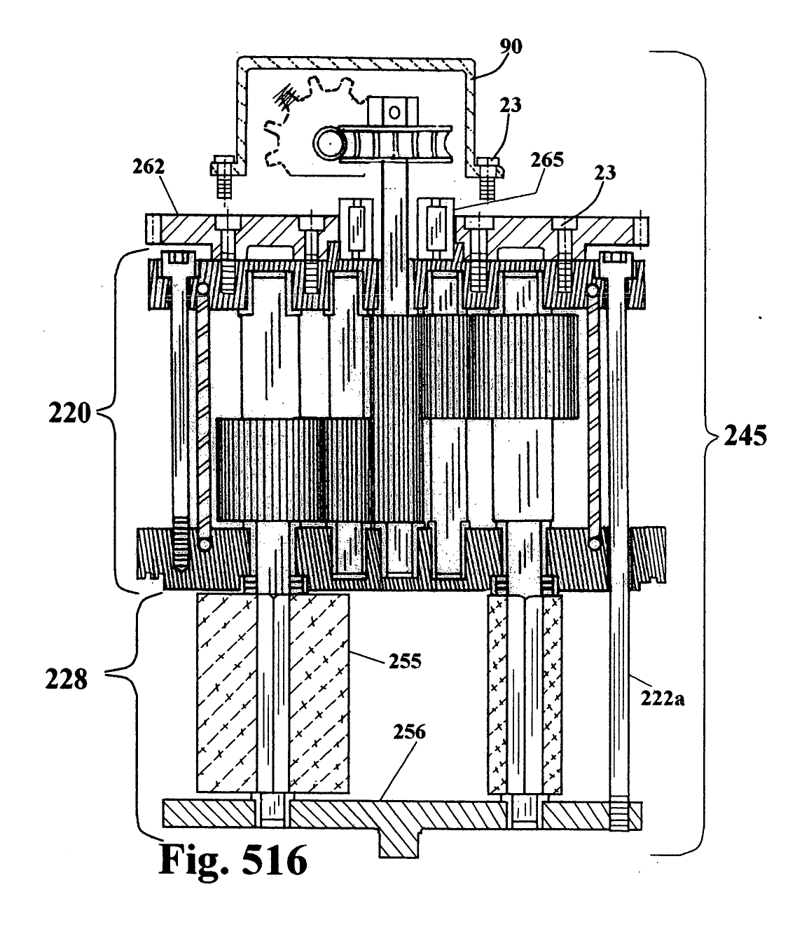

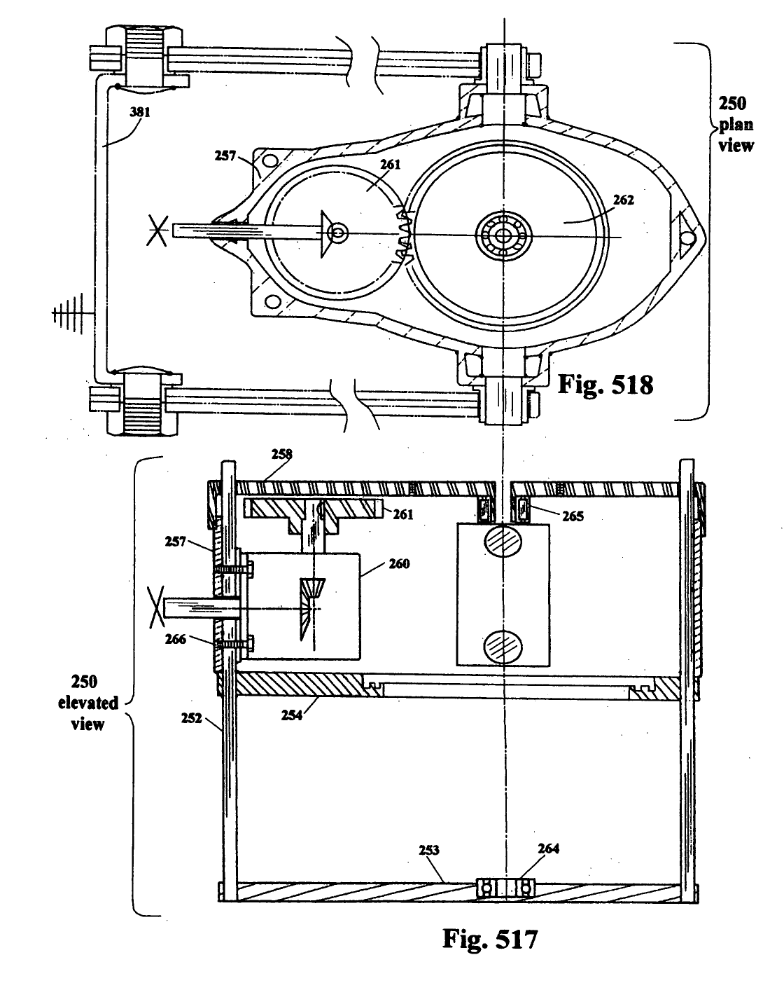

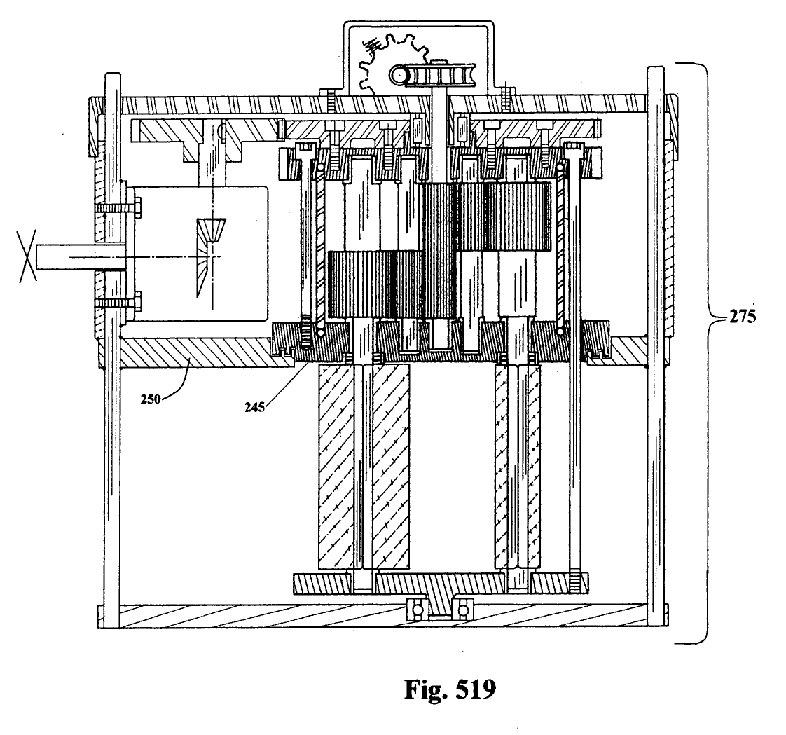

9. A transformation of the #200 Epicyclical Hybrid Gearing Control System by means of utilizing the #220 Parallel Axis Gearing segment and replacing the #225 Angular Axis Gearing segment by means of intimately joined a #228 Panemone Propulsion Blades segment by the use of a plurality of #222a threaded fasteners;
Whereby a #245 Focused Fluid Power Emission Device is utilized in a variety of propulsion tasks. (FIG. 516)

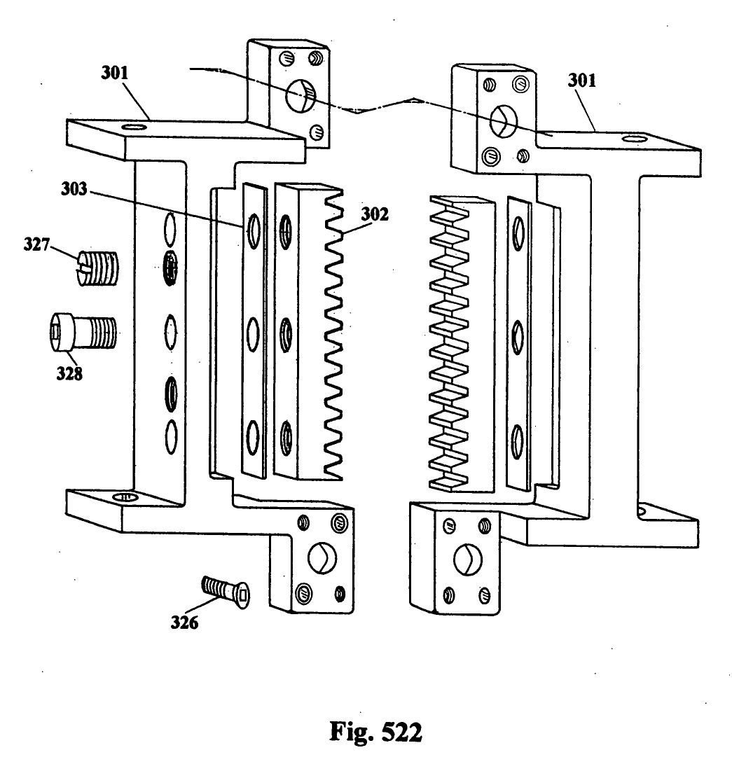

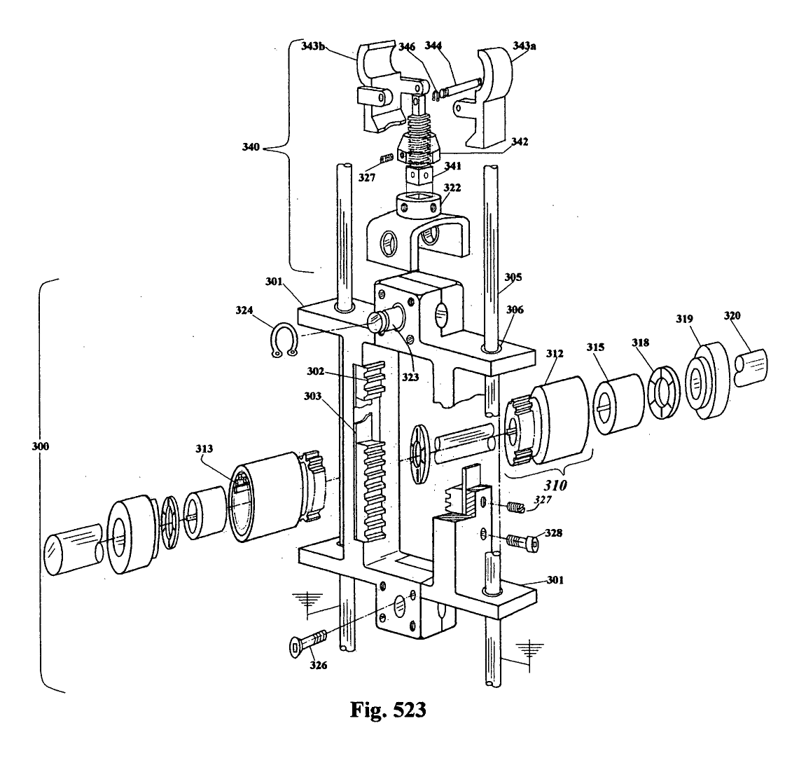

10. An apparatus as illustrated in FIGS. 522; 523; 524 of component parts assembled into a said Asynchronous Linear Reciprocating Inching Device # 300 comprising:
Slideable frame for anchoring gear racks #301,
Spur gear racks #302,
Backlash control shims #303,
Guide rails or rods #305,
Bushings #306,
Stub gear-housing (with inserted roller clutch) sub-assembly #310.
Housing for combination of stub gear and roller clutch #312,
Roller clutch #313,
Inner race for roller clutch # 315,
Thrust bearing #318,
Spacing washers #318a,
Sealed bearing #319,
Output shaft #320,
Rocker arm #322,
Rolling pin #323,
Retainer pin #324,
Flat head fastener #326,
Locking screw for rack shims #327,
Threaded fastener for shims # 328,
Grease seals #329; 329a,
Roller bearings #330,
Splined coupling #331,
Internal snap ring #332,
Encasement box #333,
Flat sealing gasket #334,
Encasement cover plate #335,
Grease retaining boot #336,
Threaded extension shaft #341,
Expansion screw #342,
Clasping clamp pair #343a, 343b,
Leverage pin #344,
Retaining ring, #346,
Whereby, a said ALRID RecipVATAS #300 is activated by rotary powered cranking activity.

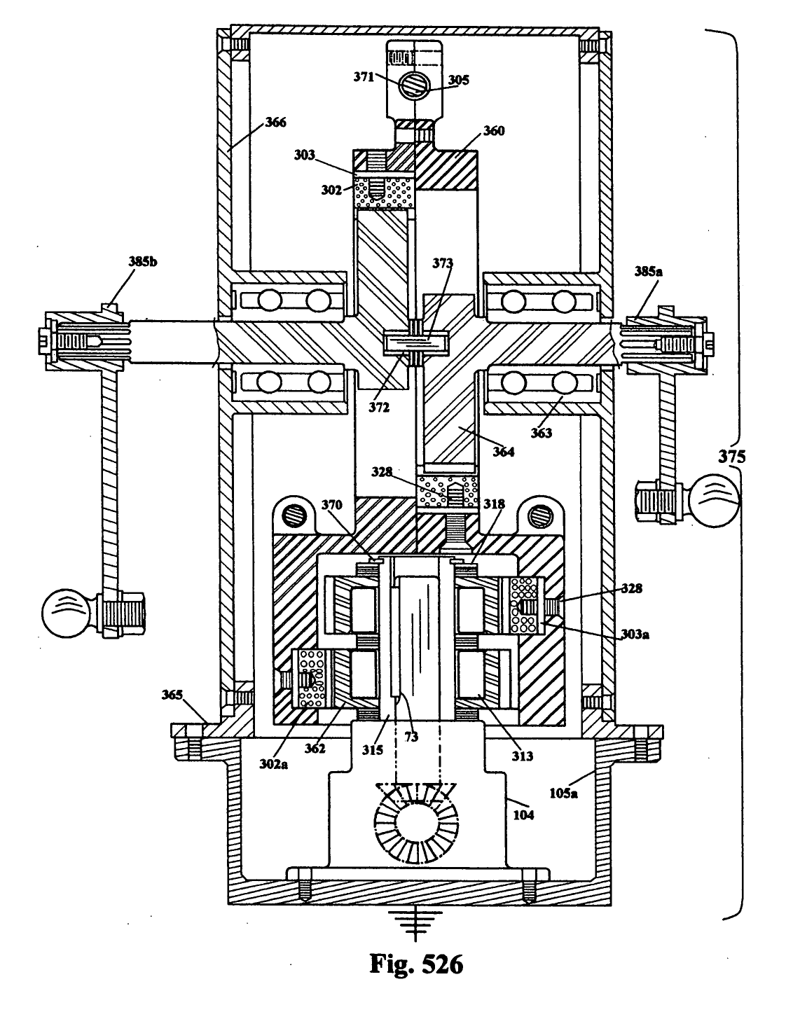

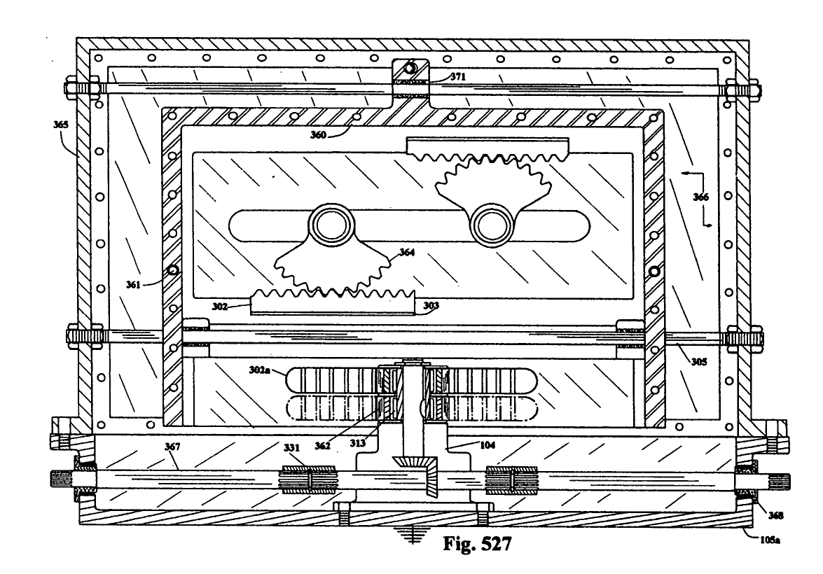

11. An apparatus as illustrated in FIGS. 524, 526 and 527 of component elements assembled into #375 Armsand Legs HuManual Engine comprising:
Locking key #73,
Right angle (type E) gear drive assembly #104,
Mounting box for Right angle driver #105,
Gear racks #302; 302a,
Backlash control shim #303; 303a,
Guide rod #305,
Roller clutch #313,
Inner Race for roller clutch #315,
Thrust bearing set #318,
Threaded fastener #328,
Splined coupling #331,
Slideable dual framework for intimately attaching multiple gear racks #360,
Alignment dowel #361,
Stub gear and clutch housing #362,
Double row bearings #363,
Quarter gears and shaft combination #364,
Anchored encasement #365,
Facing covers #366,
Splined extension shafts #367,
Threaded bushing #368,
Internal retaining ring #370,
Bronze bushing #371,
Roller bearings #372,
Alignment shaft #373,
Swinging arms and swivel balls #385a and 385b,
Whereby; multiple human bodies compound their physical energy to drive a rotary power shaft.

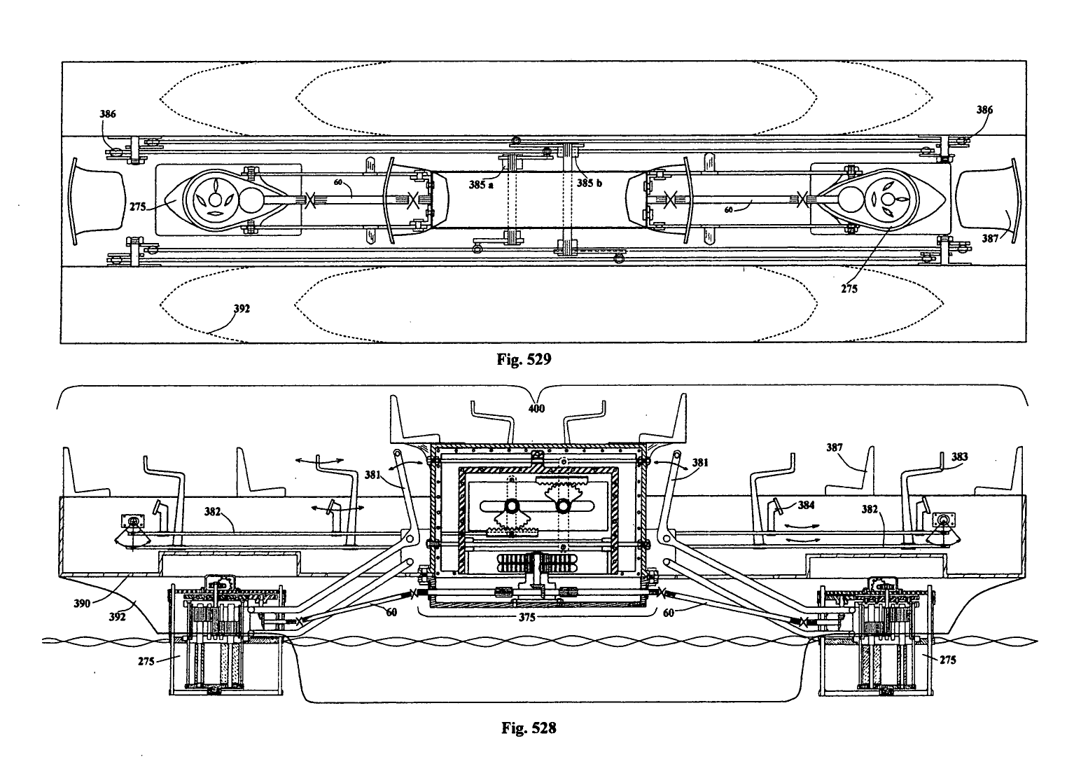

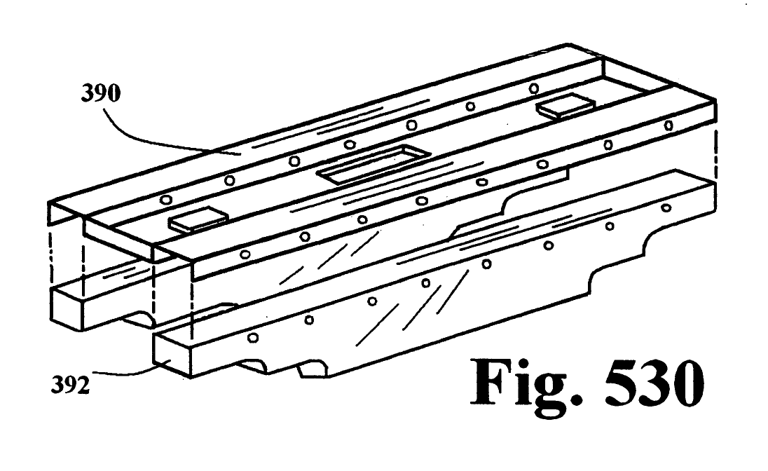

12. Implement as illustrated in FIGS. 528, 529 and 530 of component parts assembled into a nautical transportation device identified as KatKanFLOW comprising:
Dual commercial U-joint devices #60,
Dual focused nautical propulsion instruments, # 275,
Armsand Legs humanual engine, #375
Dual parallel arms lifting apparatus #381,
Parallel asynchronous curves motion rods #382,
Upper torso handle bars # 383
Lower torso pedals #384,
Pivoting suspension drive assemblies #385a and #385b,
Commercial free swinging suspension pivots #386,
Plurality of adjustable seats #387,
Hull framework #390,
Dual pontoons #392,
Thereby: providing the empirical means of judging aspects of the Limacon and Lemniscate planar curves in specific nautical transport propulsion instruments.
References Cited
U.S. PATENT DOCUMENTS

| Number | Date | | | Divisional |
|---|---|---|---|---|
| Assigned | Granted | Inventor | Classification | Relationship |
| 1,766,765 | June 1930 | Savonius | 416/132R | 20; |
| 1,820,529 | August 1931 | Darrieus | 416/119X | 20; |
| 2,073,383 | March 1937 | C. W. Allen | 74/136 | 20; 300; 400; |
| 3,702,188 | November 1972 | C. E. Phillips, et al | 482/113 | 20; 300; |
| 3,710,631 | January 1973 | D. Gladow | 74/89.2 | 20; 300; |
| 3,727,913 | April 1973 | H. Glasser; C. Steuber; | 482/62 | 20; 300; 400; |
| 3,758,112 | September 1973 | G. Crum; R. Sauter | 482/112 | 20; 300; 400; |
| 3,850,043 | November 1974 | Tarbox | 74/89.2 | 20; 200 |
| 3,954,282 | May 1976 | D. Hege | 280/251 | 20; 300; 400; |
| 3,955,430 | May 1976 | M. Rhoads | 74/89.2 | 20; 300; |
| 4,038,821 | August 1977 | J. Black | 60/398 | 20; 200 |
| 4,095,422 | June 1978 | Kurake | 60/398 | 20; 200; |
| 4,108,578 | August 1978 | Corey | 417/331 | 20; 300; 400; |
| 4,115,027 | September 1978 | Thomas | 415/2 | 20; |
| 4,115,028 | September 1978 | Hintze | 415/2 | 20; |
| 4,133,344 | January 1979 | Hunter | 137/344 | 20; 200; |
| 4,180,367 | December 1979 | Drees | 416/119 | 20; |
| 4,684,126 | August 1987 | Dalebout, et al | 482/138 | 20; 300; 400 |
| 4,725,194 | February 1988 | Bartsch | 415/4 | 20; |
| 4,842,268 | June 1989 | Jenkins | 482/ | 20; 300; |
| 4,869,494 | August 1989 | Lambert | 482/60 | 20; 300; 400 |
| 5,087,183 | February 1992 | Edwards | 418/265 | 20; |
| 5,242,179 | August 1993 | Beddome, et al | 482/62 | 20; 300; 400 |
| 5,356,356 | June 1993 | Hildebrant, et al | 482/62 | 20; 200; |
| 5,379,736 | January 1995 | Anderson | 123/204 | 20; 200; |
| 5,509,866 | April 1996 | Weightman | 475/343 | 20; 200; |
| 5,855,470 | January 1999 | Holmes | 416/11 | 20; |
| 6,016,014 | January 2000 | Grigorescu | 290/55 | 20; 200; |
| 6,042,518 | March 2000 | Hildebrant; et al | 482/57 | 20; 200; |
| 6,064,123 | January 2000 | Gislason | 290/55 | 20; |
| 6,072,244 | June 2000 | Tonouchi | 290/55 | 20; |
| 6,113,350 | September 2000 | Hsun-Fa Liu | 416/11 | 20; |
| 6,113,353 | September 2000 | Sato, et al | 416/232 | 20; 50; |
| 6,132,172 | October 2000 | Wan-Tsai Li | 416/11 | 20; |
| 6,132,181 | October 2000 | McCabe | 417/334 | 20; 300; |
| 20020144503 | October 2002 | Merswolke | 60/398 | 20, |
| 20030001393 | January 2003 | Staikos | 290/55 | 20, |
| 20040066045 | April 2004 | Aguilar | 290/55 | 20, |
| 20040156710 | August 2004 | Gaskell | 415/169.1 | 20, |
| 20040172946 | September 2004 | Gray | 60/698 | 20, 300; |
| 20050079054 | April 2005 | Kurita | 416/132B | 20; 200 |
